(19) United States
(12) Patent Application Publication
(10) Pub. No.: US 2020/0115653 A1
(43) Pub. Date: Apr. 16, 2020

(54) Viscoelastic, Solid Surfactant Composition Having A High Surfactant Content

(71) Applicant: Henkel AG & Co. KGaA, Duesseldorf (DE)

(72) Inventors: Filiz Yapici, Duesseldorf (DE); Peter Schmiedel, Duesseldorf (DE); Boray Torun, Duesseldorf (DE)

(73) Assignee: Henkel AG & Co. KGaA, Duesseldorf (DE)

(21) Appl. No.: 16/716,038

(22) Filed: Dec. 16, 2019

Related U.S. Application Data
(63) Continuation of application No. PCT/EP2018/065467, filed on Jun. 12, 2018.

(30) Foreign Application Priority Data
Jun. 16, 2017 (DE) 102017210141.5
Jun. 16, 2017 (DE) 102017210143.1
Dec. 20, 2017 (DE) 102017223460.1

(51) Int. Cl. C11D 1/83; C11D 3/20; C11D 1/00; C11D 17/00

(52) U.S. Cl. CPC C11D 1/83; C11D 3/2068; C11D 17/003; C11D 1/002; C11D 3/2096

(57) ABSTRACT

A viscoelastic solid surfactant composition for textile treatment having, based on the total weight thereof, (i) a total amount of 30 to 70 wt % of at least one surfactant, wherein at least one anionic surfactant and at least one non-ionic surfactant are present, and (ii) a total amount of 0.01 to 1 wt % of at least one organic gelating compound having a molar mass <1,000 g/mol, a solubility in water of less than 0.1 g/l (20° C.) and a structure including at least one hydrocarbon structural unit having 6 to 20 carbon atoms and additionally an organic structural unit covalently bonded to the aforementioned hydrocarbon unit, which organic structural unit has at least two groups selected from —OH—, —NH— or mixtures thereof, and (iii) water, represents a readily soluble, aesthetically appealing and storage-stable form of a solid composition for preparing washing liquor including surfactant.

### FIELD OF THE INVENTION

The present invention concerns the technical field of solid surfactant compositions for providing surfactant-containing liquors for treating textiles, in particular for cleaning textiles.

### BACKGROUND OF THE INVENTION

Textile treatment agents are usually present in solid form (for example as a powder or tablets) or in liquid form (or also as a flowing gel). Liquid washing or cleaning agents in particular are increasingly popular with consumers.

Solid textile treatment agents have the advantage that, unlike liquid textile treatment agents, they do not require any preservatives and the ingredients contained (e.g. bleaching agents or enzymes) can be incorporated in a more stable manner. Liquid product formats are increasingly gaining acceptance in the market, particularly due to their quick solubility and the resulting quick availability of the active ingredients they contain.

Consumers have grown accustomed to the convenient dosing of preportioned machine textile treatment agents, such as washing agent pouches, and use these products in the form of tablets (solid textile treatment agents) or in the form of pouches (also known as pillows) that are usually filled with at least one textile treatment agent. However, as well as the above-mentioned advantages, the use of liquids has the drawback, for example, that the liquid textile treatment agent runs out when there are leakages in the pouch of the portion.

Single-use portions in water-soluble pouches are also popular with consumers because of the attractive appearance of the single-use portion. The appearance of the dosage form is becoming increasingly important. Besides good cleaning performance and sufficient storage stability, a good appearance is one of the reasons on which the selection of a product is based. In particular transparent products are considered visually appealing by consumers. Solid surfactant compositions used for cleaning textiles are usually opaque. It is therefore an object to provide translucent to transparent solid surfactant compositions.

From the perspective of consumers, it is also desirable to combine the advantages of the product formats of solid and liquid agents and to provide a dosage form that is improved in comparison with the prior art, particularly for detergents or cleaning agents that are usually liquids. For this purpose, single-use portioning of the contained components has to be possible and a visual appearance that is attractive to consumers, in particular transparency or translucency, has to be achieved simultaneously.

### BRIEF SUMMARY OF THE INVENTION

In particular when using solid shaped bodies, which have to be dissolved or dispersed in an aqueous medium for application to a substrate, it is particularly important for the solid to dissolve well in water. When dosing single-use portions together with the laundry into the drum of the washing machine, the single-use portion has to be rapidly incorporated into the aqueous, liquid liquor, such that laundry (e.g. textile) in contact with the shaped body in the drum does not suffer any damage by lasting excess concentration of the ingredients of the surfactant composition. The object of the invention is therefore that of providing solid surfactant compositions, in particular as a single-use portion in the form of a shaped body in a pellet, which compositions can dissolve well upon contact with water or can be dispersed in water.

WO 02/086074 A1 discloses viscoelastic, solid surfactant compositions having a storage modulus of from 40,000 to 800,000 Pa. The viscoelastic surfactant compositions disclosed therein are liquid-crystalline surfactant phases. The preparation of the viscoelastic surfactant compositions of the prior art depends on the surfactants contained in each case, which restricts the freedom in terms of the formulation with respect to the selection of surfactants and the use amounts thereof

WO 2010/108002 discloses flowable surfactant compositions having a yield point which contain 0.01 to 1 wt. % dibenzylidene sorbitol as the gelator compound.

It has been shown that this object can be achieved by means of a formulation of a composition containing at least one surfactant and at least one organic gelator compound having a molar mass <1,000 g/mol, a solubility in water of less than 0.1 g/l (20° C.) and a structure containing at least one hydrophobic group (preferably at least one carbocyclic, aromatic structural unit) and at least two groups selected from —OH, —NH—, or mixtures thereof (preferably at least one benzylidene alditol compound). However, the use of high amounts of organic gelator compound of more than 1 wt. % is required for this. It has now in turn surprisingly been ascertained that the object can be achieved in an aqueous medium at a surfactant content of at least 30 wt. % and also with gelator amounts of from 0.01 to 1 wt. % when a mixture of selected surfactants is used.

In a first embodiment, the invention therefore relates to a viscoelastic, solid surfactant composition containing, based on the total weight thereof,
(i) a total amount of from 30 to 70 wt. % surfactant, wherein at least one anionic surfactant and at least one non-ionic surfactant are contained,

and
(ii) a total amount of from 0.01 to 1 wt. % of at least one organic gelator compound having a molar mass <1,000 g/mol, a solubility in water of less than 0.1 g/l (20° C.) and a structure containing at least one hydrocarbon structural unit having 6 to 20 carbon atoms (preferably at least one carbocyclic, aromatic structural unit) and additionally an organic structural unit covalently bonded to the above-mentioned hydrocarbon unit, which structure has at least two groups selected from —OH, —NH—, or mixtures thereof

and
(iii)water.

In a second embodiment, the invention particularly preferably relates a viscoelastic, solid surfactant composition containing, based on the total weight thereof,
(i) a total amount of from 30 to 70 wt. % surfactant, wherein at least one anionic surfactant and at least one non-ionic surfactant are contained,

and
(ii) a total amount of from 0.01 to 1 wt. % of at least one organic gelator compound having a molar mass <1,000 g/mol, a solubility in water of less than 0.1 g/l (20° C.) and a structure containing at least one hydrocarbon structural unit having 6 to 20 carbon atoms (preferably at least one carbocyclic, aromatic structural unit) and additionally an organic structural unit covalently bonded to the above-mentioned hydrocarbon unit, which structure has at least two groups selected from —OH, —NH—, or mixtures thereof

and
(iii) water,
   with the proviso that the composition has a storage modulus between 10³ Pa and 10⁸ Pa, preferably between 10⁴ Pa and 10⁸ Pa and a loss modulus (at 20° C., a deformation of 0.1% and a frequency of 1 Hz), and the storage modulus in the frequency range between 10⁻² Hz and 10 Hz is at least two times greater than the loss modulus. The composition further preferably has a storage modulus in a range of from 10⁵ Pa to 10⁷ Pa.

To further optimize stability properties of said composition, it is preferable if the storage modulus is at least five times greater than the loss modulus, particularly preferably at least ten times greater than the loss modulus (in each case at 20° C., a deformation of 0.1% and a frequency of 1 Hz).

### DETAILED DESCRIPTION OF THE INVENTION

All subsequently mentioned definitions and preferred embodiments apply equally to the first embodiment and the second embodiment unless otherwise specified.

The viscoelastic, solid surfactant composition combines all the advantages of a liquid composition, is an esthetic product format with a good dissolution profile in the context of textile treatment with an excellent performance on the substrate. WO 2010/108002 discloses structured liquid surfactant compositions which contain at most 1 wt. % of a benzylidene alditol compound as the structurant. Viscoelastic, solid surfactant compositions containing benzylidene alditol compounds are not described therein.

The viscoelastic, solid surfactant composition of the present invention is storage stable and dimensionally stable. Said viscoelastic, solid surfactant composition itself has almost no syneresis during long periods of storage.

A substance (e.g. a composition) is solid according to the definition of the invention if it is in a solid state of aggregation at 20° C. and 1013 mbar.

The water solubility is determined at 20° C. in desalinated water.

As is known, and therefore according to the invention, a substance (e.g. a composition) is viscoelastic and solid if the storage modulus of the substance at 20° C. is greater than the existing loss modulus. When a mechanical force acts on the substance, the substance both has the properties of an elastic solid and also demonstrates a viscosity similar to that of a liquid. The terms storage modulus and loss modulus and determining the values of these moduli are habitually familiar to a person skilled in the art (cf. Christopher W. Macosco, “Rheology Principles, Measurements and Applications,” VCH, 1994, page 121 ff. or Gebhard Schramm, “Einführung in die Rheologie and Rheometrie” [“Introduction to Rheology and Rheometry” ], Karlsruhe, 1995, page 156 ff. or WO 02/086074 A1, page 2, 3rd paragraph to page 4, end of 1st paragraph).

The rheological characterization is carried out within the scope of this invention using a rotational rheometer, for example AR-G2 type from the company TA Instruments, “Kinexus” from the company Malvern, using a cone-and-plate measuring system with a 40 mm diameter and 2° opening angle at a temperature of 20° C. In this case, the rheometer is a controlled shear stress rheometer. However, the determination can also be carried out using other instruments or measuring geometries of comparable specifications. To determine the rheological parameters of the viscoelastic, solid composition, it is recommended to prepare the solid, viscoelastic composition in the measuring device. In the process, the sample is poured in in the liquid state, is solidified in the measuring device and is then measured.

The storage modulus (abbreviation: G′) and the loss modulus (abbreviation: G″) (unit in each case: Pa) were measured using the above-described device configuration in an experiment with oscillating deformation. To this end, the linear viscoelastic region is first determined in a “stress sweep experiment.” The shear stress amplitude is here increased at a constant frequency of e.g. 1 Hz. The moduli G′ and G″ are plotted in a double logarithmic plot. The shear stress amplitude or the (resulting) deformation amplitude can optionally be plotted on the x-axis. In this case, the storage modulus G′ is constant below a certain shear stress amplitude or deformation amplitude and above this amplitude drops. The break point is expediently determined by placing tangents on the two curve portions. The corresponding deformation amplitude or shear stress amplitude is usually referred to as “critical deformation” or “critical shear stress.”

To determine the frequency dependence of the moduli, a frequency ramp, e.g. between 0.01 Hz and 10 Hz, is performed at a constant deformation amplitude. The deformation amplitude has to be selected such that it is in the linear region, e.g. below the above-mentioned critical deformation. In the case of the compositions according to the invention, a deformation amplitude of 0.1% has proved to be suitable. The moduli G′ and G″ are plotted against frequency in a double logarithmic plot.

A substance (e.g. a composition) is liquid according to the definition of the invention if it is in a liquid state of aggregation at 20° C. and 1013 mbar.

A chemical compound or the structural unit thereof is organic if the molecular structure thereof contains at least one covalent bond between carbon and hydrogen.

Conversely to the definition of “organic,” a chemical compound or the structural unit thereof is then inorganic if the molecular structure thereof does not contain a covalent bond between carbon and hydrogen.

The average molar masses specified within the scope of this application for polymeric ingredients are always, unless specifically characterized otherwise, weight-average molar masses M_{w} which can be determined in principle by means of gel permeation chromatography using an RI detector, the measurement expediently being carried out against an external standard.

Within the meaning of the invention, a surfactant-containing liquor is a liquid preparation, for treating a substrate, that can be obtained by using a surfactant-containing agent and diluting with at least one solvent (preferably water). Woven fabrics or textiles (for example clothes) can be used as the substrate. The portions according to the invention are preferably used to provide a surfactant-containing liquor in the context of automatic cleaning processes, as carried out for textiles by a washing machine, for example.

“At least one,” as used herein, refers to 1, 2, 3, 4, 5, 6, 7, 8, 9 or more. In connection with components of the compositions described herein, this information does not refer to the absolute amount of molecules, but to the type of the component. “At least one inorganic base” therefore signifies, for example, one or more different inorganic bases, which is to say one or more different types of inorganic bases. Together with stated amounts, the stated amounts refer to the total amount of the correspondingly designated type of component.

If number ranges from one number to another number are defined within the scope of the application, the limit values are included in the range.

If number ranges between one number and another number are defined within the scope of the application, the limit values are not included in the range.

The compositions of the invention preferably have a yield point. The yield point refers to the lowest stress (force per surface area) above which a plastic substance behaves rheologically like a liquid. It is given in pascals (Pa).

The yield points of the compositions were measured using an AR-G2-type rotational rheometer from the company TA Instruments. This is what is known as a controlled shear stress rheometer. In order to measure a yield point using a controlled shear stress rheometer, various methods are described in the literature that are known to a person skilled in the art.

In order to determine the yield points within the scope of the present invention, the following was carried out at 20° C.:

Shear stress σ increasing gradually over time was applied to the samples in the rheometer in a stepped-flow procedure. For example, the shear stress can be increased from the smallest possible value (e.g. 2 mPa) to e.g. 10 Pa over the course of 10 minutes with 10 points per shear stress decade. In this process, the time interval is selected such that the measurement is carried out “quasistatically,” i.e. such that the deformation of the sample for each specified shear stress value can come into equilibrium. The equilibrium deformation γ of the sample is measured as a function of this shear stress. The deformation is plotted against the shear stress in a double-logarithmic plot. Provided that the sample tested has a yield point, a distinction can clearly be made between two regions in this plot. Below a certain shear stress, purely elastic deformation occurs in accordance with Hooke's law. The gradient of the curve γ(σ) (log-log plot) in this region is one. Above this shear stress, the yield region begins and the gradient of the curve rises steeply. The shear stress at which the curve breaks off sharply, i.e. the transition from elastic to plastic deformation, marks the yield point. It is possible to easily determine the break point by applying tangents to the two parts of the curve. Samples without a yield point do not have a characteristic break in the γ(δ) function.

The solid, viscoelastic composition according to the invention preferably has a yield point in the range of from 2.5 to 100 Pa, more preferably from 3 to 80 Pa (cone-and-plate measuring system with 40 mm diameter and 2° opening angle at a temperature of 20° C.).

The viscoelastic, solid surfactant composition according to the invention is preferably transparent or translucent. If, in the spectral range between 380 nm and 780 nm, a mixture according to the invention has a residual brightness, based on the reference measurement, of at least 20%, it is considered transparent within the meaning of the invention.

The transparency of the surfactant composition according to the invention can be determined using various methods. The Nephelometric Turbidity Unit (NTU) is often used as a measured value for transparency. This is a unit, for example used in water treatment, for turbidity measurements, for example in liquids. It is a unit of a turbidity measured using a calibrated nephelometer. High NTU values are measured for cloudy surfactant compositions, whereas low values are determined for clear, transparent surfactant compositions.

The use of the turbidimeter of the HACH Turbidimeter 2100Q type from Hach Company, Loveland, Colo. (USA), is carried out using the calibration substances StabICal Solution HACH (20 NTU), StabICal Solution HACH (100 NTU) and StabICal Solution HACH (800 NTU), which can all likewise be ordered from Hach Company. The measurement is carried out in 10 ml sample cell with cap filled with the composition to be tested and the measurement is carried out at 20° C.

At an NTU value (at 20° C.) of 60 or more, the surfactant compositions have a perceptible turbidity that is visible to the naked eye within the meaning of the invention. It is therefore preferable if the surfactant compositions according to the invention have an NTU value (at 20° C.) of at most 120, preferably at most 110, more preferably at most 100, particularly preferably at most 80.

Within the scope of the present invention, the transparency of the solid agents according to the invention was determined by means of a transmission measurement in the visible light spectrum over a wavelength range of from 380 nm to 780 nm at 20° C. For this purpose, a reference sample (water, deionized) in a photometer (Specord S 600 from the company Analytik Jena) is first measured using a cuvette (layer thickness 10 mm) that is transparent in the spectrum to be tested. The cuvette is subsequently filled with a sample of the surfactant composition according to the invention and measured again. In the process, the sample is poured in in the liquid state and solidified in the cuvette and then measured.

It is preferred if the transparent surfactant composition according to the invention has a transmission (at 20° C.) of at least 25%, preferably at least 30%, more preferably at least 35%, even more preferably at least 40%, in particular at least 50% and particularly preferably at least 60%.

It is most particularly preferred if the transparent surfactant composition according to the invention has a transmission (at 20° C.) of at least 25% (in particular at least 25%, preferably at least 30%, more preferably at least 35%, even more preferably at least 40%, in particular at least 50%, particularly preferably at least 60%) and an NTU value (at 20° C.) of at most 120 (preferably at most 110, more preferably at most 100, even more preferably at most 80).

The viscoelastic, solid surfactant composition according to the invention contains, based on the total weight thereof, a total amount of from 30 to 70 wt. % surfactant. Anionic surfactants, non-ionic surfactants, zwitterionic surfactants, amphoteric surfactants or cationic surfactants that are preferred according to the invention can be used as the surfactants. At least one anionic surfactant and at least one non-ionic surfactant are necessarily contained in the surfactant composition according to the invention.

Preferred surfactant compositions contain, based on the total weight thereof, a total amount of from 30 to 65 wt. %, preferably 30 to 60 wt. %, more preferably 35 to 70 wt. %, even more preferably 35 to 65 wt. %, especially preferably 35 to 60 wt. %, particularly preferably 40 to 70 wt. %, more particularly preferably 40 to 65 wt. %, even more particularly preferably 40 to 60 wt. %, surfactant. These surfactant compositions are likewise suitable for treating textiles, but in particular for use in a washing machine for washing textiles.

A viscoelastic, solid surfactant composition according to the invention is characterized in that it contains at least one anionic surfactant. Surfactant compositions according to the invention comprising an anionic surfactant are suitable e.g. for washing textiles, particularly preferably for use in a washing machine for washing textiles.

It is preferred according to the invention if anionic surfactant is contained in the surfactant composition according to the invention, based on the total weight of the composition, in a total amount of from 5 to 60 wt. %, preferably 10 to 60 wt. %, more preferably 15 to 60 wt. %, in particular 20 to 60 wt. %, particularly preferably 15 to 40 wt. %, more particularly preferably 20 to 40 wt. %.

Sulfonates and/or sulfates may preferably be used as the anionic surfactant. It is preferable for the surfactant composition according to the invention to contain a mixture of sulfonate and sulfate surfactants.

The surfactant compositions according to the invention preferably contain at least one anionic surfactant selected from C₉-C₁₃ alkylbenzene sulfonates, olefin sulfonates, C₁₂-C₁₈ alkane sulfonates, ester sulfonates, alk(en)yl sulfonates, alkyl ether sulfates (in particular fatty alcohol ether sulfates), and mixtures thereof. Compositions according to the invention which comprise at least one C₉-C₁₃ alkylbenzene sulfonate and at least one (C₁₀-C₂₀) fatty alcohol ether sulfate as the anionic surfactant are particularly preferred.

Surfactants of the sulfonate type that can be used are preferably C₉-C₁₃ alkylbenzene sulfonates, olefin sulfonates (i.e. mixtures of alkene and hydroxyalkane sulfonates, and disulfonates, as obtained, for example, from C₁₂-C₁₈ monoolefins having a terminal or internal double bond by way of sulfonation with gaseous sulfur trioxide and subsequent alkaline or acid hydrolysis of the sulfonation products). C₁₂-C₁₈ alkane sulfonates and the esters of α-sulfofatty acids (ester sulfonates), for example the α-sulfonated methyl esters of the hydrogenated coconut, palm kernel or tallow fatty acids, are also suitable.

The alkali salts and in particular the sodium salts of the sulfuric acid semi-esters of C₁₂-C₁₈ fatty alcohols, for example from coconut fatty alcohol, tallow fatty alcohol, lauryl, myristyl, cetyl or stearyl alcohol, or of C₁₀-C₂₀ oxo alcohols and the semi-esters of secondary alcohols having this chain length are preferred as the alk(en)yl sulfates. From a washing perspective, the C₁₂-C₁₆, C₁₂-C₁₅ alkyl sulfates and C₁₄-C₁₅ alkyl sulfates are preferred. 2,3-Alkyl sulfates are also suitable anionic surfactants.

The salts of the sulfuric acid semi-esters of fatty alcohols having 12 to 18 C atoms, for example from coconut fatty alcohol, tallow fatty alcohol, lauryl, myristyl, cetyl or stearyl alcohol, or of oxo alcohols having 10 to 20 C atoms and the semi-esters of secondary alcohols having this chain length are preferred as the alk(en)yl sulfates. From a washing perspective, the alkyl sulfates having 12 to 16 C atoms and alkyl sulfates having 12 to 15 C atoms as well as alkyl sulfates having 14 and 15 C atoms are preferred. 2,3-Alkyl sulfates are also suitable anionic surfactants.

The use of at least one alkyl ether sulfate, such as in particular at least one sulfuric acid monoester of the straight-chain or branched C₁₀-C₂₀ alcohols ethoxylated with 1 to 6 mol of ethylene oxide (for example 2-methyl-branched C₉₋₁₁ alcohols having, on average, 3.5 mol ethylene oxide (EO) or C₁₂₋₁₈ fatty alcohols having 1 to 4 mol EO) are particularly preferably suitable.

Alkyl ether sulfate is preferably contained in a total amount of from 3 to 30 wt. %, in particular 3 to 20 wt. %, based on the total weight of the viscoelastic surfactant composition.

At least one alkyl ether sulfate having the formula (A-1)

R′—O-(AO)ₙ—SO_{3′}X⁺ (A-1)

in which
R¹ represents a linear or branched, substituted or unsubstituted (C₁₀-C₂₀) alkyl functional group (preferably a linear, unsubstituted (C₁₀-C₂₀) alkyl functional group),
AO represents an ethylene oxide (EO) group or propylene oxide (PO) group, the index n is a number from 1 to 50,
X⁺ is a monovalent cation or the nth part of an n-valent cation,
is thus preferably contained in the surfactant composition according to the invention.

R¹ of the formula (A-1) particularly preferably represents a fatty alcohol functional group. Preferred functional groups R¹ of the formula (A-1) are selected from decyl, undecyl, dodecyl, tridecyl, tetradecyl, pentadecyl, hexadecyl, heptadecyl, octadecyl, nonadecyl, eicosyl functional groups, and mixtures thereof, the representatives having an even number of carbon atoms being preferred. Particularly preferred R¹ functional groups of the formula (A-1) are derived from fatty alcohols having 12 to 18 carbon atoms (for example from coconut fatty alcohol, tallow fatty alcohol, lauryl, myristyl, cetyl or stearyl alcohol), or from branched oxo alcohols having 10 to 20 carbon atoms.

In formula (A-1), AO represents an ethylene oxide (EO) group or propylene oxide (PO) group, preferably an ethylene oxide group.

The index n of formula (A-1) is preferably a number from 1 to 20, and in particular from 1 to 10. Most particularly preferably, n is 1, 2, 3, 4, 5, 6, 7 or 8, more preferably 1, 2, 3 or 4.

X⁺ of formula (A-1) represents a monovalent cation or the nth part of an n-valent cation, in this case the alkali metal ions, which include Na⁺ or K⁺, being preferred, Na⁺ being most preferred. Further cations X⁺ can be selected from NH₄⁺, ½ Zn²⁺, ½ Mg²⁺, ½ Ca²⁺, ½ Mn²⁺, and mixtures thereof

Particularly preferred washing agents contain an alkyl ether sulfate selected from fatty alcohol ether sulfates of formula A-2

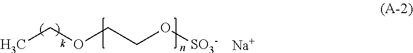

where k=11 to 19, and n=2, 3, 4, 5, 6, 7 or 8. Very particularly preferred representatives are Na fatty alcohol ether sulfates having 12 to 18 C atoms and 2 EO (k=11 to 13 and n=2 in formula A-1). The degree of ethoxylation indicated represents a statistical average that can correspond to an integer or a fractional number for a specific product. The degrees of alkoxylation indicated represent statistical averages that can correspond to an integer or a fractional number for a specific product. Preferred alkoxylates/ethoxylates have a narrowed homolog distribution (narrow range ethoxylates, NRE).

It is preferred if at least one anionic surfactant of formula (A-3) is contained in the surfactant composition according to the invention,

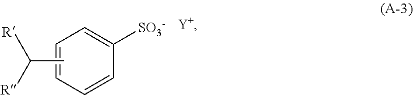

in which
R′ and R″ are, independently, H or alkyl, and together contain 9 to 19, preferably 9 to 15 and in particular 9 to 13 C atoms, and indicates a monovalent cation or the nth part of an n-valent cation (in particular Na^{t}).

Additional suitable anionic surfactants are soaps. Saturated and unsaturated fatty acid soaps are suitable, such as the salts of lauric acid, myristic acid, palmitic acid, stearic acid, (hydrogenated) erucic acid and behenic acid, and in particular soap mixtures derived from natural fatty acids, such as coconut, palm kernel, olive oil or tallow fatty acids.

The anionic surfactants can be present in the form of the sodium, potassium, magnesium or ammonium salts thereof. The anionic surfactants are preferably present in the form of the ammonium salts thereof, said ammonium ion being derived from at least one (C₂-C₆) alkanolamine. According to the invention, the term “(C₂ bis C₆) alkanolamine” is understood to mean organic amine compounds which have a carbon skeleton consisting of two to six carbon atoms to which the at least one amino group (preferably exactly one amino group) and at least one hydroxyl group (once again preferably exactly one hydroxyl group) are bonded.

Within the scope of the invention, it is preferable to use at least one (C₂ to C₆) alkanolamine having precisely one amino group. A primary amine is in turn preferred in this case.

The agent according to the invention preferably contains at least one (C₂ to C₆) alkanolamine selected from 2-aminoethane-1-ol (monoethanolamine), tris(2-hydroxyethyl)amine (triethanolamine), 3-aminopropane-1-ol, 4-aminobutane-1-ol, 5-aminopentane-1-ol, 1-aminopropane-2-ol, 1-aminobutane-2-ol, 1-aminopentane-2-ol, 1-aminopentane-3-ol, 1-aminopentane-4-ol, 3-amino-2-methylpropane-1-ol, 1-amino-2-methylpropane-2-ol, 3-aminopropane-1,2-diol, 2-amino-2-methylpropane-1,3-diol (in particular from 2-aminoethane-1-ol, 2-amino-2-methylpropane-1-ol, 2-amino-2-methyl-propane-1,3-diol), or mixtures thereof

Monoethanolamine has proven to be a (C₂ to C₆) alkanolamine that is very particularly suitable as an alkalizing agent. Other preferred counterions for contained anionic surfactant are the protonated forms of choline, triethylamine and methyl ethylamine.

In a very particularly preferred embodiment, the surfactant composition contains at least one alkylbenzene sulfonic acid neutralized with monoethanolamine (in particular C₉₋₁₃ alkylbenzene sulfonic acid, more preferably of formula (A-3) (vide supra)) and/or at least one alkyl ether sulfate of formula (A-1) neutralized with monoethanolamine (vide supra) (in particular of formula (A-2) (vide supra)).

The surfactant composition according to the invention additionally necessarily contains at least one non-ionic surfactant.

The surfactant compositions according to the invention preferably contain 5 to 35 wt. %, in particular 10 to 30 wt. %, of at least one non-ionic surfactant.

In a preferred embodiment of the invention, the surfactant compositions described herein contain, as the non-ionic surfactant, at least one fatty alcohol alkoxylate having the following formula (N-1),

R′—O—(XO)ₘ—H (N-1)

where R′ is a linear or branched C₈-C₁₈ alkyl functional group, an aryl functional group or alkyl aryl functional group, XO, independently of one another, is an ethylene oxide (EO) or propylene oxide (PO) group and m is an integer from 1 to 50.

In the above formula (N-1), R′ represents a linear or branched, substituted or unsubstituted alkyl functional group. In a preferred embodiment of the present invention, R′ of formula (N-1) is a linear or branched alkyl functional group having 5 to 30 carbon atoms, preferably having 7 to 25 carbon atoms and in particular having 10 to 19 carbon atoms.

Preferred R′ functional groups are selected from decyl, undecyl, dodecyl, tridecyl, tetradecyl, pentadecyl, hexadecyl, heptadecyl, octadecyl, nonadecyl functional groups, and mixtures thereof, the representatives having an even number of carbon atoms being preferred. Particularly preferred R′ functional groups are derived from fatty alcohols having 12 to 19 carbon atoms, for example from coconut fatty alcohol, tallow fatty alcohol, lauryl, myristyl, cetyl or stearyl alcohol or from branched oxo alcohols having 10 to 19 carbon atoms.

XO of formula (N-1) is an ethylene oxide (EO) or propylene oxide (PO) group, preferably an ethylene oxide group.

The index m of formula (N-1) is an integer from 1 to 50, preferably 2 to 20, and more preferably 2 to 10. In particular, m is 3, 4, 5, 6 or 7. The surfactant composition according to the invention may contain mixtures of non-ionic surfactants which have different degrees of ethoxylation.

In summary, particularly preferred fatty alcohol alkoxylates are those of formula (N-2)

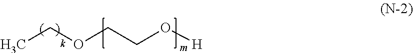

where k=9 to 17 and m=3, 4, 5, 6 or 7. More particularly preferred representatives are fatty alcohols having 10 to 18 carbon atoms and 7 EO (k=11 to 17 and m=7).

Fatty alcohol ethoxylates of this kind are available under the commercial names Dehydol® LT7 (BASF), Lutensol® A07 (BASF), Lutensol® M7 (BASF) and Neodol® 45-7 (Shell Chemicals).

The surfactant compositions according to the invention particularly preferably contain non-ionic surfactants from the group of the alkoxylated alcohols. Non-ionic surfactants that are preferably used are alkoxylated, advantageously ethoxylated, in particular primary, alcohols having preferably 8 to 18 C atoms and, on average, 1 to 12 mol of ethylene oxide (EO) per mol of alcohol, in which alcohols the alcohol functional group can be linear or preferably methyl-branched in the 2 position, or can contain linear and methyl-branched functional groups in admixture, as are usually present in oxo alcohol functional groups, for example. In particular, however, alcohol ethoxylates having linear functional groups from alcohols of native origin having 12 to 18 C atoms, for example from coconut, palm, tallow fat, or oleyl alcohol, and on average 2 to 8 EO per mol of alcohol are preferred. Examples of preferred ethoxylated alcohols include C₁₂₋₁₄ alcohols having 3 EO or 4 EO, C₈₋₁₁ alcohol having 7 EO, C₁₃₋₁₅ alcohols having 3 EO, 5 EO, 7 EO or 8 EO, C₁₂₋₁₈ alcohols having 3 EO, 5 EO or 7 EO, and mixtures thereof, such as mixtures of C₁₂₋₁₄ alcohol having 3 EO and C₁₂₋₁₈ alcohol having 5 EO.

Preferred alcohol ethoxylates have a narrowed homolog distribution (narrow range ethoxylates, NRE). In addition to these non-ionic surfactants, fatty alcohols having more than 12 EO can also be used. Examples of these are tallow fatty alcohols having 14 EO, 25 EO, 30 EO, or 40 EO.

Ethoxylated non-ionic surfactants are particularly preferably used which were obtained from C₆₋₂₀ monohydroxy alkanols or C₆₋₂₀ alkyl phenols or C₁₆₋₂₀ fatty alcohols and more than 12 mol, preferably more than 15 mol, and in particular more than 20 mol of ethylene oxide per mol of alcohol. A particularly preferred non-ionic surfactant is obtained from a straight-chain fatty alcohol having 16 to 20 carbon atoms (C₁₆₋₂₀ alcohol), preferably from a C₁₈ alcohol and at least 12 mol, preferably at least 15 mol and in particular at least 20 mol of ethylene oxide. Among these, the so-called “narrow-range ethoxylates” are particularly preferred.

Surfactants that are preferably used originate from the group of the alkoxylated non-ionic surfactants, in particular the ethoxylated primary alcohols and mixtures of these surfactants with structurally more complicated surfactants such as polyoxypropylene/polyoxyethylene/polyoxypropylene ((PO/EO/PO) surfactants). Such (PO/EO/PO) non-ionic surfactants are also characterized by good foam control.

The surfactant composition according to the invention may additionally contain amine oxide as the non-ionic surfactant. In principle, all the amine oxides established in the prior art for this purpose, i.e. compounds that have the formula R¹R²R³NO, in which each of R¹, R² and R³, independently of one another, is an optionally substituted hydrocarbon chain having 1 to 30 carbon atoms, can be used as the amine oxide. Amine oxides that are particularly preferably used are those in which R¹ is alkyl having 12 to 18 carbon atoms and R² and R³ are each independently alkyl having 1 to 4 carbon atoms, in particular alkyl dimethyl amine oxides having 12 to 18 carbon atoms. Examples of representatives of suitable amine oxides are N-coconut alkyl-N,N-dimethyl amine oxide, N-tallow alkyl-N,N-dihydroxyethyl amine oxide, myristyl/cetyl dimethyl amine oxide or lauryl dimethyl amine oxide.

Suitable non-ionic surfactants include alkyl glycosides of general formula RO(G)ₓ, for example, in which R corresponds to a primary straight-chain or methyl-branched aliphatic functional group, in particular an aliphatic functional group that is methyl-branched in the 2 position, having 8 to 22, preferably 12 to 18, C atoms, and G is the symbol that represents a glycose unit having 5 or 6 C atoms, preferably glucose. The degree of oligomerization x, which indicates the distribution of monoglycosides and oligoglycosides, is any number between 1 and 10; x is preferably between 1.2 and 1.4.

Another class of non-ionic surfactants that are preferably used, which are used either as the sole non-ionic surfactant or in combination with other non-ionic surfactants, are alkoxylated, preferably ethoxylated or ethoxylated and propoxylated fatty acid alkyl esters, preferably having 1 to 4 carbon atoms in the alkyl chain.

Additional suitable surfactants are the polyhydroxy fatty acid amides that are known as PHFAs.

Further non-ionic surfactants which can be used may be, for example:
polyol fatty acid esters;
alkoxylated triglycerides;
alkoxylated fatty acid alkyl esters of formula R³CO—(OCH₂CHR⁴)_{w}OR⁵, in which R³CO represents a linear or branched, saturated and/or unsaturated acyl functional group having 6 to 22 carbon atoms, R⁴ represents hydrogen or methyl, R⁵ represents linear or branched alkyl groups having 1 to 4 carbon atoms, and w is 1 to 20;
hydroxy mixed ethers;
sorbitan fatty acid esters and addition products of ethylene oxide with sorbitan fatty acid esters such as the polysorbates;
sugar fatty acid esters and addition products of ethylene oxide with sugar fatty acid esters;
addition products of ethylene oxide with fatty acid alkanolamides and fatty amines;
fatty acid-N-alkyl glucamides.

The surfactant compositions according to the invention described herein may also contain a plurality of the above-described non-ionic surfactants.

Viscoelastic, solid surfactant compositions that are particularly preferred according to the invention contain, in each case based on the total weight, a total amount of
from 10 to 60 wt. %, in particular 25 to 40 wt. %, of at least one anionic surfactant and
from 5 to 35 wt. %, in particular 10 to 30 wt. %, of at least one non-ionic surfactant.

Viscoelastic, solid surfactant compositions according to the invention that are very particularly preferred according to the invention contain, in addition to water and said benzylidene alditol compound, at least one surfactant combination, as is described in the following for compositions (A) to (D):
(A) a viscoelastic, solid surfactant composition, containing as the surfactant, in each case based on the total weight of the composition, at least a total amount in each case of
   from 10 to 60 wt. % of at least one anionic surfactant, at least one C₉-13 alkylbenzene sulfonate being contained as the anionic surfactant, and
   from 2 to 35 wt. % of at least one non-ionic surfactant, at least one alkoxylated alcohol having 8 to 18 carbon atoms and on average 4 to 12 mol ethylene oxide (EO) per mol of alcohol being contained as the non-ionic surfactant;
(B) a viscoelastic, solid surfactant composition, containing as the surfactant, in each case based on the total weight of the composition, at least a total amount in each case of
   from 10 to 60 wt. % of at least one anionic surfactant, at least 5 to 60 wt. % of at least one C₉₋₁₃ alkylbenzene sulfonate being contained as the anionic surfactant, and
   from 5 to 35 wt. % of at least one non-ionic surfactant, at least 5 to 35 wt. % of at least one alkoxylated alcohol having 8 to 18 carbon atoms and on average 4 to 12 mol ethylene oxide (EO) per mol of alcohol being contained as the non-ionic surfactant;
(C) a viscoelastic, solid surfactant composition, containing as the surfactant, in each case based on the total weight of the composition, at least a total amount in each case of
   from 25 to 40 wt. % of at least one anionic surfactant, at least one C₉-13 alkylbenzene sulfonate being contained as the anionic surfactant, and
   from 10 to 30 wt. % of at least one non-ionic surfactant, at least one alkoxylated alcohol having 8 to 18 carbon atoms and on average 4 to 12 mol ethylene oxide (EO) per mol of alcohol being contained as the non-ionic surfactant;
(D) a viscoelastic, solid surfactant composition, containing as the surfactant, in each case based on the total weight of the composition, at least a total amount in each case of
   from 25 to 40 wt. % of at least one anionic surfactant, at least 25 to 40 wt. % of at least one C₉-13 alkylbenzene sulfonate being contained as the anionic surfactant, and
   from 10 to 30 wt. % of at least one non-ionic surfactant, at least 10 to 30 wt. % of at least one alkoxylated alcohol having 8 to 18 carbon atoms and on average 4 to 12 mol ethylene oxide (EO) per mol of alcohol being contained as the non-ionic surfactant.

In this case, such embodiments from (A), (B), (C) and (D) are again yet more preferred if they contain, in each case based on the total weight of the composition, at least a total amount of from 3 to 30 wt. %, in particular 3 to 20 wt. %, of at least one alkyl ether sulfate of formula (A-1)

R¹—O-(AO)ₙ—SO₃′X⁺ (A-1)

in which
R¹ represents a linear or branched, substituted or unsubstituted (C₁₀-C₂₀) alkyl functional group (preferably a linear, unsubstituted (C₁₀-C₂₀) alkyl functional group),
AO represents an ethylene oxide (EO) group or propylene oxide (PO) group,
the index n is a number from 1 to 50,
X⁺ is a monovalent cation or the nth part of an n-valent cation,
in the surfactant composition according to the invention.

When preparing all of the above-mentioned surfactant compositions using specific amounts of selected surfactant, the amounts of the individual surfactant components are naturally to be selected within the specified amount ranges of the individual surfactant components such that the prespecified total amount of surfactant is maintained.

It is preferred according to the invention if the viscoelastic, solid surfactant composition according to the invention additionally contains at least one polyalkoxylated polyamine.

The polyalkoxylated polyamine in the scope of the present invention and the individual aspects thereof is a polymer having an N-atom-containing backbone which carries polyalkoxy groups on the N atom. At the ends (terminus and/or side chains), the polyamine has primary amino functions and, in the interior, preferably has both secondary and tertiary amino functions; it may optionally also have only secondary amino functions in the interior, resulting in a linear polyamine rather than a branched-chain polyamine. The ratio of primary to secondary amino groups in the polyamine is preferably in the range of from 1:0.5 to 1:1.5, in particular in the range of from 1:0.7 to 1:1. The ratio of primary to tertiary amino groups in the polyamine is preferably in the range of from 1:0.2 to 1:1, in particular in the range of from 1:0.5 to 1:0.8. The polyamine preferably has an average molar mass in the range of from 500 g/mol to 50,000 g/mol, in particular from 550 g/mol to 5,000 g/mol. The N atoms in the polyamine are separated from one another by alkylene groups, preferably by alkylene groups having 2 to 12 C atoms, in particular 2 to 6 C atoms, with not all alkylene groups needing to have the same number of C atoms. Ethylene groups, 1,2-propylene groups, 1,3-propylene groups, and mixtures thereof, are particularly preferred. Polyamines which carry ethylene groups as said alkylene group are also referred to as polyethylene imine or PEI. PEI is a polymer, having an N-atom-containing backbone, that is particularly preferred according to the invention.

The primary amino functions in the polyamine can carry 1 or 2 polyalkoxy groups and the secondary amino functions can carry 1 polyalkoxy group, with not every amino function having to be alkoxy-group-substituted. The average number of alkoxy groups per primary and secondary amino function in the polyalkoxylated polyamine is preferably 1 to 100, in particular 5 to 50. The alkoxy groups in the polyalkoxylated polyamine are preferably polypropoxy groups which are directly bonded to N atoms, and/or polyethoxy groups which are bonded to optionally present propoxy functional groups and to N atoms which do not carry propoxy groups.

Polyethoxylated polyamines are obtained by reacting polyamines with ethylene oxide (EO for short). The polyalkoxylated polyamines which contain ethoxy and propoxy groups are preferably obtainable by reacting polyamines with propylene oxide (PO for short) and subsequently reacting with ethylene oxide.

The average number of propoxy groups per primary and secondary amino function in the polyalkoxylated polyamine is preferably 1 to 40, in particular 5 to 20.

The average number of ethoxy groups per primary and secondary amino function in the polyalkoxylated polyamine is preferably 10 to 60, in particular 15 to 30.

If desired, the terminal OH function polyalkoxy substituents in the polyalkoxylated polyamine can be partially or completely etherified with a C₁-C₁₀, in particular C₁-C₃ alkyl group.

Polyalkoxylated polyamines that are particularly preferred according to the invention can be selected from polyamine reacted with 45 EO per primary and secondary amino function, PEIs reacted with 43 EO per primary and secondary amino function, PEIs reacted with 15 EO+5 PO per primary and secondary amino function, PEIs reacted with 15 PO and 30 EO per primary and secondary amino function, PEIs reacted with 5 PO+39.5 EO per primary and secondary amino function, PEIs reacted with 5 PO+15 EO per primary and secondary amino function, PEIs reacted with 10 PO +35 PO per primary and secondary amino function, PEIs reacted with 15 PO+30 PO per primary and secondary amino function and PEIs reacted with 15 PO+5 EO per primary and secondary amino function. A most particularly preferred alkoxylated polyamine is PEI having a content of from 10 to 20 nitrogen atoms reacted with 20 units of EO per primary or secondary amino function of the polyamine.

The invention additionally preferably relates to the use of polyalkoxylated polyamines which can be obtained by reacting polyamines with ethylene oxide and optionally additionally propylene oxide. If, as well as ethylene oxide and propylene oxide, polyalkoxylated polyamines are used, the proportion of propylene oxide with respect to the total amount of the alkylene oxide is preferably 2 mol. % to 18 mol. %, in particular 8 mol. % to 15 mol. %.

The viscoelastic, solid surfactant composition according to the invention preferably contains, based on the weight thereof, additionally polyalkoxylated polyamines in a total amount of from 0.5 to 12 wt. %, in particular 5.0 to 9.0 wt. %.

In a further preferred embodiment, the viscoelastic, solid surfactant composition according to the invention contains additionally at least one soil release active ingredient. Soil-releasing substances are often referred to as “soil release” active ingredients or, owing to their capability of finishing the treated surface, preferably textiles, in a soil-repellent manner, as “soil repellents.” Due to their chemical similarity to polyester fibers, particularly effective soil release active ingredients, which however can also demonstrate the desired effect for woven fabrics made of another material, are copolyesters which contain dicarboxylic acid units, alkylene glycol units and polyalkylene glycol units. Soil release polyesters of the mentioned type as well as the use thereof preferably in washing agents for textiles have been known for a long time.

For example, polymers made of ethylene terephthalate and polyethylene oxide terephthalate in which the polyethylene glycol units have molecular weights of from 750 to 5,000 and the mol ratio of ethylene terephthalate to polyethylene oxide terephthalate is 50:50 to 90:10, and the use thereof in washing agents, is described in the German patent specification DE 28 57 292. Polymers having a molecular weight of from 15,000 to 50,000 and made of ethylene terephthalate and polyethylene oxide terephthalate, the polyethylene glycol units having molecular weights of from 1,000 to 10,000 and the mol ratio of ethylene terephthalate to polyethylene oxide terephthalate being 2:1 to 6:1, can be used in washing agents according to the German published patent application DE 33 24 258. The European patent EP 066 944 relates to textile treatment agents which contain a copolyester made of ethylene glycol, polyethylene glycol, aromatic dicarboxylic acid and sulfonated aromatic dicarboxylic acid in specific mol ratios. The European patent EP 185 427 discloses methyl- or ethyl-group-end-capped polyesters having ethylene- and/or propylene-terephthalate units and polyethylene oxide terephthalate units and washing agents which contain soil release polymers of this kind. The European patent EP 241 984 relates to a polyester which, in addition to oxyethylene groups and terephthalic acid units, also contains substituted ethylene units and glycerol units. The European patent EP 241 985 discloses polyesters which, in addition to oxyethylene groups and terephthalic acid units, contain 1,2 propylene, 1,2 butylene and/or 3-methoxy-1,2 propylene groups, as well as glycerol units, and are end-capped with C₁-C₄ alkyl groups. The European patent specification EP 253 567 relates to soil release polymers having a molar mass of from 900 to 9,000 and made of ethylene terephthalate and polyethylene oxide terephthalate, the polyethylene glycol units having a molecular weight of from 300 to 3,000 and the mol ratio of ethylene terephthalate to polyethylene oxide terephthalate being 0.6 to 0.95. The European patent application EP 272 033 discloses, at least partially, polyesters end-capped by C₁₋₄ alkyl or acyl functional groups and having polypropylene terephthalate and polyoxy ethylene terephthalate units. The European patent EP 274 907 describes sulfoethyl-end-capped, terephthalate-containing soil release polyesters. In the European patent application EP 357 280, unsaturated end-group soil release polymers having terephthalate, alkylene glycol and poly-C₂₋₄-glycol units are prepared by sulfonation.

In a preferred embodiment of the invention, the surfactant composition according to the invention contains at least one soil release polyester containing the structural units E-I to E-III or E-I to E-IV,

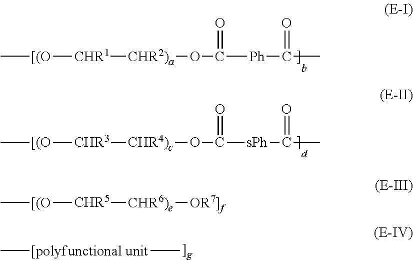

in which
a, b and c represent, independently of one another, a number from 1 to 200,
d, e and f represent, independently of one another, a number from 1 to 50,
g represents a number from 0 to 5,
Ph represents a 1,4-phenyl functional group,
sPh represents a 1,3-phenylene functional group substituted with a —SO₃M group in the 5 position,
M represents Li, Na, K, Mg/2, Ca/2, AI/3, ammonium, mono-, di-, tri- or tetraalkylammonium, the alkyl functional groups of the ammonium ions being C₁-C₂₂ alkyl or C₂-C₁₀ hydroxyalkyl functional groups or any mixtures thereof,
R¹, R², R³, R⁴, R⁵ and R⁶ represent, independently of one another, hydrogen or a C₁-C₁₈ n- or iso-alkyl group,
R⁷ represents a linear or branched C₁-C₃₀ alkyl group or a linear or branched C₂-C₃₀ alkenyl group, a cycloalkyl group having 5 to 9 carbon atoms, a C₆-C₃₀ aryl group or a C₆-C₃₀ arylalkyl group, and polyfunctional unit represents a unit having 3 to 6 functional groups capable of esterification reaction.

Preference is given to polyesters in which R¹, R², R³, R⁴, R⁵ and R⁶ each represent, independently of one another, hydrogen or methyl, R⁷ represents methyl, a, b and c each represent, independently of one another, a number from 1 to 200, in particular 1 to 20, particularly preferably 1 to 5, extremely preferably a and b=1 and c can be a number from 2 to 10, d signifies a number between 1 and 25, in particular between 1 and 10, particularly preferably between 1 and 5, e signifies a number between 1 and 30, in particular between 2 and 15, particularly preferably between 3 and 10 and f signifies a number between 0.05 and 15, in particular between 0.1 and 10 and particularly preferably between 0.25 and 3. Polyesters of this kind can be obtained, for example, by polycondensation of terephthalic acid dialkyl esters, 5-sulfoisophthalic acid dialkyl esters, alkylene glycols, optionally polyalkylene glycols (with a, b and/or c>1) and single-end-capped polyalkylene glycols (corresponding to unit E-III). Reference should be made to the fact that for numbers a, b, c>1, there is a polymeric skeleton and thus the coefficients can assume any value in the given interval as the average. The number-average molecular weight reflects this value. An ester of terephthalic acid with one or more difunctional, aliphatic alcohols can be used as unit (E-I); ethylene glycol (R¹ and R² each H) and/or 1,2-propylene glycol (R¹═H and R²═—CH₃ or vice versa) and/or shorter-chain polyethylene glycols and/or poly[ethylene glycol-co-propylene glycol] having number-average molecular weights of from 100 to 2,000 g/mol are preferably used. 1 to 50 (E-I) units per polymer chain may be contained in the structures, for example. An ester of 5-sulfoisophthalic acid with one or more difunctional, aliphatic alcohols can be used as unit (E-II); the above-mentioned esters are preferably used. 1 to 50 (E-II) units may be present in the structures, for example. Poly [ethylene glycol-co-propylene glycol] monomethyl ethers having average molecular weights of from 100 to 2,000 g/mol and polyethylene glycol monomethyl ethers of general formula CH₃—O—(C₂H₄O)ₙ—H, where n=1 to 99, in particular 1 to 20 and particularly preferably 2 to 10, are preferably used as non-ionic single-end-capped polyalkylene glycol monoalkyl ethers according to unit (E-III). Since, by using single end-capped ethers of this kind, the theoretic maximum average molecular weight of a polyester structure to be achieved during a quantitative reaction is predetermined, the preferred amount of structural unit (E-III) used is considered to be that required to achieve the average molecular weights described in the following. In addition to linear polyesters resulting from structural units (E-I), (E-II) and (E-III), the use of cross-linked or branched polyester structures is also in accordance with the invention. This is expressed by the presence of a polyfunctional structural unit (E-IV) that acts in a cross-linking manner and has at least three to at most six functional groups capable of esterification reaction. In this case acid, alcohol, ester, anhydride or epoxy groups can be mentioned as functional groups, for example. Different functionalities in one molecule are also possible here. Citric acid, malic acid, tartaric acid and gallic acid, particularly preferably 2,2-dihydroxy methyl propionic acid, can be used as examples. Polyhydric alcohols such as pentaerythrol, glycerol, sorbitol and/or trimethylolpropane can also be used. Examples may also include polyvalent aliphatic or aromatic carboxylic acids such as benzene-1,2,3-tricarboxylic acid (hemimellitic acid), benzene-1,2,4-tricarboxylic acid (trimellitic acid) or benzen-1,3,5-tricarboxylic acid (trimesic acid). The weight proportion of cross-linked monomers, based on the total mass of the polyester, can be up to 10 wt. %, in particular up to 5 wt. % and particularly preferably up to 3 wt. %, for example. The polyesters containing the structural units (E-I), (E-II) and (E-III) and optionally (E-IV) generally have number-average molecular weights in the range of from 700 to 50,000 g/mol, it being possible to determine the number-average molecular weight by size-exclusion chromatography in aqueous solution using calibration with the aid of a narrowly distributed polyacrylic acid-Na salt standard. The number-average molecular weights are preferably within the range of from 800 to 25,000 g/mol, in particular 1,000 to 15,000 g/mol, particularly preferably 1,200 to 12,000 g/mol. Solid polyesters which have a softening point above 40° C. are preferably used according to the invention as a component of the particle of the second type; they preferably have a softening point between 50 and 200° C., particularly preferably between 80° C. and 150° C. and extremely preferably between 100° C. and 120° C. The polyesters can be synthesized by known methods, for example by the above-mentioned components first being heated at normal pressure with addition of a catalyst and then the required molecular weights being built up in a vacuum by distilling off hyperstoichiometric amounts of the glycols used. Known transesterification and condensation catalysts are suitable for the reaction, for example titanium tetraisopropylate, dibutyltin oxide, alkali or alkaline-earth metal alcoholates or antimony trioxide/calcium acetate. Reference is made to EP 442 101 for further details.

The viscoelastic, solid surfactant composition according to the invention may additionally contain at least one enzyme. In principle, all the enzymes found in the prior art for this purpose can be used in this regard. This at least one enzyme is preferably one or more enzymes which can develop catalytic activity in a surfactant-containing liquor, in particular a protease, amylase, lipase, cellulase, hemicellulase, mannanase, pectin-cleaving enzyme, tannase, xylanase, xanthanase, ß-glucosidase, carrageenanase, perhydrolase, oxidase, oxidoreductase, and mixtures thereof. Hydrolytic enzymes that are preferably suitable include in particular proteases, amylases, in particular α-amylases, cellulases, lipases, hemicellulases, in particular pectinases, mannanases, ß-glucanases, and mixtures thereof. Proteases, amylases and/or lipases, and mixtures thereof, are particularly preferred, and proteases are very particularly preferred. In principle, these enzymes are of natural origin; starting from the natural molecules, improved variants for use in washing or cleaning agents are available which are correspondingly preferably used.

Among the proteases, the subtilisin-type proteases are preferred. Examples thereof are subtilisins BPN′ and Carlsberg, protease PB92, subtilisins 147 and 309, the alkaline protease from Bacillus lentus, subtilisin DY, and the enzymes thermitase, proteinase K and the proteases TW3 and TW7, which belong to the subtilases but no longer to the subtilisins in the narrower sense. Subtilisin Carlsberg is available in a developed form under the trade name Alcalase® from the company Novozymes A/S, Bagsvaerd, Denmark. Subtilisins 147 and 309 are sold under the trade names Esperase® and Savinase®, respectively, from the company Novozymes. The protease variants referred to by the name BLAP® are derived from the proteases from Bacillus lentus DSM 5483. Other suitable proteases are, for example, the enzymes available under the trade names Durazym®, Relase®, Everlase®, Nafizym®, Natalase®, Kannase® and Ovozyme® from the company Novozymes, the enzymes available under the trade names Purafect®, Purafect® OxP, Purafect® Prime, Excellase® and Properase® from the company Genencor, the enzyme available under the trade name Protoso® from the company Advanced Biochemicals Ltd., Thane, India, the enzyme available under the trade name Wuxi® from the company Wuxi Snyder Bioproducts Ltd., China, the enzymes available under the trade names Proleather® and Protease P® from the company Amano Pharmaceuticals Ltd., Nagoya, Japan, and the enzyme available under the name Proteinase K-16 from the company Kao Corp., Tokyo, Japan. The proteases from Bacillus gibsonii and Bacillus pumilus are also particularly preferably used.

Examples of amylases that are used according to the invention are the α-amylases from Bacillus licheniformis, from B. amyloliquefaciens or from B. stearothermophilus, as well as the developments thereof that have been improved for use in washing or cleaning agents. The enzyme from B. licheniformis is available from the company Novozymes under the name Termamyl® and from the company Genecor under the name Purastar®ST. Development products of said α-amylase are available from the company Novozymes under the trade names Duramyl® and Termamyl® ultra, from the company Genencor under the name Purasta®OxAm and from the company Daiwa Seiko Inc., Tokyo, Japan, as Keistase®. The α-amylase from B. amyloliquefaciens is sold by the company Novozymes under the name BAN®, and derived variants of the α-amylase from B. stearothermophilus are sold under the names BSG® and Novamyl®, likewise by the company Novozymes. Others that are particularly noteworthy for this purpose are the α-amylases from Bacillus sp. A 7-7 (DSM 12368) and cyclodextrin glucanotransferase (CGTase) from B. agaradherens (DSM 9948). Fusion products of all the mentioned molecules can also be used. In addition, the developments of the α-amylase from Aspergillus niger and A. oryzae which are available under the trade name Fungamyl® from the company Novozymes are suitable. Additional trade products which can be advantageously used are, for example, Amylase-LT® and Stainzyme® or Stainzyme Ultra® or Stainzyme Plus®, the latter likewise from the company Novozymes. Variants of said enzymes which can be obtained by point mutations can also be used according to the invention.

Examples of lipases or cutinases which can be used according to the invention, in particular due to their triglyceride-cleaving activities, but also in order to produce peracids in situ from suitable precursors, are the lipases which can be originally obtained or are developed from Humicola lanuginosa (Thermomyces lanuginosus), in particular those with the amino acid substitution D96L. They are sold, for example, by the company Novozymes under the trade names Lipolase®, Lipolase®Ultra, LipoPrime®, Lipozyme® and Lipex®. In addition, the cutinases which have originally been isolated from Fusarium solani pisi and Humicola insolens can be used, for example. Lipases which are likewise suitable are available from the company Amano under the names Lipase CEO, Lipase P®, Lipase B®, or Lipase CES®, Lipase AKG®, Bacillus sp. Lipase®, Lipase AP®, Lipase M-AP® and Lipase AML®. From the company Genencor, the lipases or cutinases whose starting enzymes have originally been isolated from Pseudomonas mendocina and Fusarium solanii can be used, for example. The preparations M1 Lipase® and Lipomax® originally sold by the company Gist-Brocades, the enzymes sold by the company Meito Sangyo KK, Japan, under the names Lipase MY-30®, Lipase OF® and Lipase PL®, and also the product Lumafast® from the company Genencor, should be mentioned as additional significant trade products.

Depending on the purpose, cellulases can be present as pure enzymes, as enzyme preparations or in the form of mixtures in which the individual components are advantageously complementary in terms of their different performance aspects, in particular in portions for washing textiles. These performance aspects include in particular the contributions of the cellulases to the primary washing performance of the agent (cleaning performance), to the secondary washing performance of the agent (anti-redeposition effect or graying inhibitor), to the softening (textile effect) or to the application of a “stone-washed” effect. A suitable fungal, endoglucanase (EG)-rich cellulase preparation, or the developments thereof, is provided by the company Novozymes under the trade name Celluzyme®. The products Endolase® and Carezyme®, likewise available from the company Novozymes, are based on the 50 kD-EG or the 43 kD-EG from H. insolens DSM 1800. Other trade products from this company which can be used are Cellusoft®, Renozyme® and Celluclean®. The 20 kD-EG from Melanocarpus, which are available from the company AB Enzymes, Finland, under the trade names Ecostone® and Biotouch®, can also be used, for example. Other trade products from the company AB Enzymes are Econase® and Ecopulp®. Other suitable cellulases are from Bacillus sp. CBS 670.93 and CBS 669.93, with the cellulase from Bacillus sp. CBS 670.93 being available under the trade name Puradax® from the company Genencor. Other trade products from the company Genencor are “Genencor detergent cellulase L” and IndiAge®Neutra. Variants of said enzymes which can be obtained by point mutations can also be used according to the invention. Particularly preferred cellulases are Thielavia terrestris cellulase variants, cellulases from Melanocarpus, in particular Melanocarpus albomyces, EGIII-type cellulases from Trichoderma reesei, or variants obtained therefrom.

Moreover, other enzymes, which can be grouped together under the term “hemicellulases,” can be used in particular in order to remove certain problematic stains that can be found on the substrate. These enzymes include mannanases, xanthanlyases, xanthanases, xyloglucanases, xylanases, pullulanases, pectin-cleaving enzymes and ß-glucanases, for example. The ß-glucanase obtained from Bacillus subtilis is available from the company Novozymes under the name Cereflo®. Particularly preferred hemicellulases according to the invention are mannanases, which are sold under the trade names Mannaway® from the company Novozymes or Purabrite® from the company Genencor, for example. Within the scope of the present invention, the pectin-cleaving enzymes include enzymes with the names pectinase, pectatlyase, pectinesterase, pectindemethoxylase, pectinmethoxylase, pectinmethylesterase, pectase, pectinmethylesterase, pectinoesterase, pectinpectylhydrolase, pectindepolymerase, endopolygalacturonase, pectolase, pectinhydrolase, pectin polygalacturonase, endopolygalacturonase, poly-α-1,4-galacturonide glycanohydrolase, endogalacturonase, endo-D-galacturonase, galacturan 1,4-α-galacturonidase, exopolygalacturonase, poly (galacturonate) hydrolase, exo-D-galacturonase, exo-D-galacturonanase, exopoly-D-galacturonase, exo-poly-α-galacturonosidase, exopolygalacturonosidase or exopolygalacturanosidase. Examples of enzymes which are suitable in this respect are available, for example, under the names Gamanase®, PektinexAR®, X-Pect® or Pectaway® from the company Novozymes, under the names Rohapect UF®, Rohapect TPL®, Rohapect PTE100®, Rohapect MPE®, Rohapect MA plus HC, Rohapect DA12L®, Rohapect 10L® or Rohapect B1L® from the company AB Enzymes and under the name Pyrolase® from the company Diversa Corp., San Diego, Calif., USA.

From all these enzymes, those which are comparatively stable with respect to oxidation or have been stabilized by point mutagenesis, for example, are particularly preferred. In particular the trade products Everlase® and Purafect®OxP should be mentioned as examples of such proteases and Duramyl® should be mentioned as an example of such an α-amylase.

The viscoelastic, solid surfactant composition according to the invention preferably contains enzymes in total amounts of from 1×10⁻⁸ to 5 weight percent based on active protein. The enzymes are preferably contained in a total amount of from 0.001 to 2 wt. %, more preferably 0.01 to 1.5 wt. %, even more preferably 0.05 to 1.25 wt. % and particularly preferably 0.01 to 0.5 wt. % in said portion.

In addition, builders, complexing agents, optical brighteners (preferably in portions for washing textiles), pH-adjusters, perfume, dye, dye transfer inhibitor, or mixtures thereof, may be contained in the surfactant composition according to the invention as additional ingredients.

The use of builder substances (builders) such as silicates, aluminum silicates (in particular zeolites), salts of organic di- and polycarboxylic acids, as well as mixtures of these substances, preferably water-soluble builder substances, can be advantageous.

In an embodiment that is preferred according to the invention, the use of phosphates (including polyphosphates) is omitted either largely or completely. In this embodiment, the viscoelastic, solid surfactant composition according to the invention preferably contains less than 5 wt. %, particularly preferably less than 3 wt. %, more particularly less than 1 wt. % phosphate(s). The surfactant composition according to the invention in this embodiment is particularly preferably completely phosphate-free, i.e., the compositions contain less than 0.1 wt. % phosphate(s).

The builders include, in particular, carbonates, citrates, phosphonates, organic builders, and silicates. The proportion by weight of the total builders with respect to the total weight of viscoelastic, solid composition according to the invention is preferably 15 to 80 wt. % and in particular 20 to 70 wt. %.

Some examples of organic builders that are suitable according to the invention are the polycarboxylic acids (polycarboxylates) that can be used in the form of their sodium salts, with polycarboxylic acids being understood as being those carboxylic acids that carry more than one, in particular two to eight acid functions, preferably two to six, in particular two, three, four, or five acid functions in the entire molecule. Dicarboxylic acids, tricarboxylic acids, tetracarboxylic acids, and pentacarboxylic acids, in particular di-, tri-, and tetracarboxylic acids, are thus preferred as polycarboxylic acids. The polycarboxylic acids can also carry additional functional groups such as hydroxyl or amino groups, for example. For example, these include citric acid, adipic acid, succinic acid, glutaric acid, malic acid, tartaric acid, maleic acid, fumaric acid, saccharic acids (preferably aldaric acids, for example galactaric acid and glucaric acid), aminocarboxylic acids, in particular aminodicarboxylic acids, aminotricarboxylic acids, aminotetracarboxylic acids, for example nitrilotriacetic acid (NTA), glutamic-N,N-diacetic acid (also called N,N-bis(carboxymethyl)-L-glutamic acid or GLDA), methyl glycine diacetic acid (MGDA), and derivatives thereof and mixtures thereof. Preferred salts are the salts of the polycarboxylic acids such as citric acid, adipic acid, succinic acid, glutaric acid, tartaric acid, GLDA, MGDA, and mixtures thereof

Other substances that are suitable as organic builders are polymeric polycarboxylates (organic polymers having a plurality of (in particular greater than ten) carboxylate functions in the macromolecule), polyaspartates, polyacetals, and dextrins.

In addition to their builder effect, the free acids also typically have the property of an acidification component. Particularly noteworthy here are citric acid, succinic acid, glutaric acid, adipic acid, gluconic acid, and any mixtures thereof

Particularly preferred surfactant compositions according to the invention contain one or more salts of citric acid, i.e., citrates, as one of their essential builders. These are preferably contained in a proportion of from 0.3 to 10 wt. %, in particular 0.5 to 8 wt. %, particularly 0.7 to 6.0 wt. %, particularly preferably 0.8 to 5.0 wt. %, in each case based on the total weight of the composition.

It is also particularly preferable to use carbonate(s) and/or hydrogen carbonate(s), preferably alkali carbonate(s), particularly preferably sodium carbonate (soda), in amounts of from 2 to 50 wt. %, preferably 4 to 40 wt. %, and in particular 10 to 30 wt. %, very particularly preferably 10 to 24 wt. %, each based on the weight of the viscoelastic, solid surfactant composition.

The viscoelastic, solid surfactant compositions according to the invention can contain phosphonates in particular as an additional builder. A hydroxy alkane and/or amino alkane phosphonate is preferably used as a phosphonate compound. Among the hydroxy alkane phosphonates, 1-hydroxyethane-1,1-diphosphonate (HEDP) is of particular importance. Ethylenediamine tetramethylene phosphonate (EDTMP), diethylenetriamine pentamethylene phosphonate (DTMMP) and higher homologs thereof are preferably considered as aminoalkane phosphonates. Phosphonates are preferably contained in the viscoelastic, solid surfactant compositions according to the invention in amounts of from 0.1 to 10 wt. %, in particular in amounts of from 0.3 to 8 wt. %, very particularly preferably 0.5 to 4.0 wt. %, in each case based on the total weight of the composition.

Polymeric polycarboxylates are also suitable as organic builders. These are, for example, the alkali metal salts of polyacrylic acid or polymethacrylic acid, for example those having a relative molecular mass of from 500 to 70,000 g/mol. Suitable polymers are in particular polyacrylates which preferably have a molecular mass of from 1,000 to 20,000 g/mol. Due to their superior solubility, the short-chain polyacrylates, which have molar masses of from 1,100 to 10,000 g/mol, and particularly preferably 1,200 to 5,000 g/mol, can in turn be preferred from this group.

The viscoelastic, solid surfactant compositions according to the invention can also contain, as a builder, crystalline layered silicates of general formula NaMSiₓO₂ₓ₊₁.y H₂O, where M represents sodium or hydrogen, x is a number from 1.9 to 22, preferably from 1.9 to 4, with 2, 3, or 4 being particularly preferred values for x, and y represents a number from 0 to 33, preferably from 0 to 20. Amorphous sodium silicates having a Na₂O:SiO₂ modulus of from 1:2 to 1:3.3, preferably 1:2 to 1:2.8, and in particular 1:2 to 1:2.6, can also be used which preferably have retarded dissolution and secondary washing properties.

An optical brightener is preferably selected from the substance classes of distyrylbiphenyls, stilbenes, 4,4′-diamino-2,2′-stilbene disulfonic acids, cumarines, dihydroquinolones, 1,3-diarylpyrazolines, naphthalic acid imides, benzoxazole systems, benzisoxazole systems, benzimidazole systems, pyrene derivatives substituted with heterocycles, and mixtures thereof

Particularly preferred optical brighteners include disodium-4,4′-bis-(2-morpholino-4-anilino-s-triazin-6-ylamino)stilbene disulfonate (for example available as Tinopal® DMS from BASF SE), disodium-2,2′-bis-(phenyl-styryl)disulfonate (for example available as Tinopal® CBS from BASF SE), 4,4′-bis[(4-anilino-6-[bis(2-hydroxyethyl)amino]-1,3,5-triazin-2-yl)amino]stilbene-2,2′-disulfonic acid (for example available as Tinopal® UNPA from BASF SE), hexasodium-2,2′-[vinylenebis[(3-sulphonato-4,1-phenylene)imino[6-(diethylamino)-1,3,5-triazin-4,2-diyl]imino]]bis-(benzene-1,4-disulfonate) (for example available as Tinopal® SFP from BASF SE), 2,2′-(2,5-thiophendiyl)bis[5-1,1-dimethylethyl)-benzoxazole (for example available as Tinopal® SFP from BASF SE) and/or 2,5-bis(benzoxazol-2-yl)thiophene.

It is preferable for the dye transfer inhibitor to be a polymer or copolymer of cyclic amines such as vinylpyrrolidone and/or vinylimidazole. Polymers suitable as a dye transfer inhibitor include polyvinylpyrrolidone (PVP), polyvinylimidazole (PVI), copolymers of vinylpyrrolidone and vinylimidazole (PVP-PVI), polyvinylpyridine-N-oxide, poly-N-carboxymethyl-4-vinylpyridium chloride, polyethylene-glycol-modified copolymers of vinylpyrrolidone and vinylimidazole, and mixtures thereof. Particularly preferably, polyvinylpyrrolidone (PVP), polyvinylimidazole (PVI) or copolymers of vinylpyrrolidone and vinylimidazole (PVP-PVI) are used as a dye transfer inhibitor. The polyvinylpyrrolidones (PVP) used preferably have an average molecular weight of from 2,500 to 400,000 and are commercially available from ISP Chemicals as PVP K 15, PVP K 30, PVP K 60 or PVP K 90, or from BASF as Sokalan® HP 50 or Sokalan® HP 53. The copolymers of vinylpyrrolidone and vinylimidazole (PVP-PVI) used preferably have a molecular weight in the range of from 5,000 to 100,000. A PVP-PVI copolymer is commercially available from BASF under the name Sokalan® HP 56. Other dye transfer inhibitors that can be extremely preferably used are polyethylene-glycol-modified copolymers of vinylpyrrolidone and vinylimidazole, which, for example, are available from BASF under the name Sokalan® HP 66.

In the context of a preferred embodiment according to the invention, the viscoelastic, solid surfactant composition according to the invention contains incorporated solid particles (also referred to as particles in the following). Dispersed solid particles of this kind are understood to be solid substances that do not dissolve in the condensed phase of the surfactant composition according to the invention at temperatures of up to 5° C. units above the sol-gel transition temperature of the solid surfactant composition according to the invention and are present as a separate phase. When preparing the viscoelastic surfactant compositions according to the invention, these particles are suspended in the liquid phase above the sol-gel transition temperature and the liquid phase is subsequently cooled below the sol-gel transition temperature to obtain the viscoelastic surfactant composition according to the invention.

The solid particles are preferably selected from polymers, pearlescing pigments, microcapsules, speckles, or mixtures thereof.

Within the meaning of the present invention, microcapsules include any type of capsule known to a person skilled in the art, but in particular core-shell capsules and matrix capsules. Matrix capsules are porous shaped bodies that have a structure similar to a sponge. Core-shell capsules are shaped bodies that have a core and a shell. Capsules that have an average diameter X_{50.3} (volume average) of from 0.1 to 200 μm, preferably 1 to 100 μm, more preferably 5 to 80 μm, particularly preferably 10 to 50 μm, and in particular 15 to 40 μm, are suitable as microcapsules. The average particle size diameter X_{50.3} is determined by sieving or by means of a Camsizer particle size analyzer from the company Retsch.

The microcapsules of the invention preferably contain at least one active ingredient, preferably at least one odorant. These preferred microcapsules are perfume microcapsules.

In a preferred embodiment of the invention, the microcapsules have a semi-permeable capsule wall (shell).

A semi-permeable capsule wall within the meaning of the present invention is a capsule wall that is semipermeable, i.e. continuously releases small quantities of the capsule core over time, without the capsules being destroyed or opened, e.g. by tearing. These capsules continuously release small quantities of the active ingredient contained in the capsule, e.g. perfume.

In another preferred embodiment of the invention, the microcapsules have an impermeable shell. An impermeable shell within the meaning of the present invention is a capsule wall that is substantially not permeable, i.e. only releases the capsule core by the capsule being damaged or opened. These capsules contain significant amounts of the at least one odorant in the capsule core, and therefore when the capsule is damaged or opened, a very intense fragrance is provided. The fragrance intensities thus achieved are generally so high that lower quantities of the microcapsules can be used in order to achieve the same fragrance intensity as for conventional microcapsules.

In a preferred embodiment of the invention, the surfactant composition according to the invention contains both microcapsules having a semipermeable shell and also microcapsules having an impermeable shell. By using both types of capsule, a significantly improved fragrance intensity can be provided over the entire laundry cycle.

In another preferred embodiment of the invention, the surfactant composition according to the invention may also contain two or more different microcapsule types having semipermeable or impermeable shells.

High-molecular compounds are usually considered as materials for the shell of the microcapsules, such as protein compounds, for example gelatin, albumin, casein and others, cellulose derivatives, for example methylcellulose, ethylcellulose, cellulose acetate, cellulose nitrate, carboxymethylcellulose and others, and especially also synthetic polymers such as polyamides, polyethylene glycols, polyurethanes, epoxy resins and others. Preferably, melamine formaldehyde polymers, melamine urea polymers, melamine urea formaldehyde polymers, polyacrylate polymers or polyacrylate copolymers are used as the wall material, i.e. as the shell. Capsules according to the invention are for example, but not exclusively, described in US 2003/0125222 A1, DE 10 2008 051 799 A1 or WO 01/49817.

Preferred melamine formaldehyde microcapsules are prepared by melamine formaldehyde precondensates and/or the C₁-C₄ alkyl ethers thereof in water, by the at least one odor modulator compound and optionally other ingredients, such as at least one odorant, condensing in the presence of a protective colloid. Suitable protective colloids are e.g. cellulose derivatives, such as hydroxyethyl cellulose, carboxymethyl cellulose and methylcellulose, polyvinylpyrrolidone, copolymers of N-vinylpyrrolidone, polyvinyl alcohols, partially hydrolyzed polyvinyl acetates, gelatin, arabic gum, xanthan gum, alginates, pectins, degraded starches, casein, polyacrylic acid, polymethacrylic acid, copolymerizates of acrylic acid and methacrylic acid, sulfonic-acid-group-containing water-soluble polymers having a content of sulfoethyl acrylate, sulfoethyl methacrylate or sulfopropyl methacrylate, and polymerizates of N-(sulfoethyl)-maleinimide, 2-acrylamido-2-alkyl sulfonic acids, styrene sulfonic acids and formaldehyde, and condensates of phenol sulfonic acids and formaldehyde.

It is preferable for the surface of the microcapsules used according to the invention to be coated entirely or in part with at least one cationic polymer. Accordingly, at least one cationic polymer from the group comprising polyquaternium-1, polyquaternium-2, polyquaternium-4, polyquaternium-5, polyquaternium-6, polyquaternium-7, polyquaternium-8, polyquaternium-9, poly quaternium-10, polyquaternium-11, polyquaternium-12, polyquaternium-13, polyquaternium-14, polyquaternium-15, polyquaternium-16, poly quaternium-17, polyquaternium-18, polyquaternium-19, polyquaternium-20, polyquaternium-22, polyquaternium-24, polyquaternium-27, polyquaternium-28, polyquaternium-29, polyquaternium-30, polyquaternium-31, polyquaternium-32, polyquaternium-33, polyquaternium-34, polyquaternium-35, polyquaternium-3 6, polyquaternium-37, polyquaternium-39, polyquaternium-43, polyquaternium-44, polyquaternium-45, polyquaternium-46, polyquaternium-47, polyquaternium-48, polyquaternium-49, polyquaternium-50, polyquaternium-51, polyquaternium-56, polyquaternium-57, polyquaternium-61, polyquaternium-69 or polyquaternium-86 is suitable as a cationic polymer for coating the microcapsules. Polyquaternium-7 is more particularly preferred. The polyquaternium nomenclature used in this application for the cationic polymers is taken from the declaration for cationic polymers according to the International Nomenclature of Cosmetic Ingredients (INCI declaration) for cosmetic raw materials.

Microcapsules that can preferably be used have an average diameter X_{50.3} in the range of from 1 to 100 μm, preferably 5 to 95 μm, in particular 10 to 90 μm, for example 10 to 80 μm.

The shell of the microcapsules surrounding the core or the (filled) cavity preferably has an average thickness in the range of from approximately 5 to 500 nm, preferably approximately 50 nm to 200 nm, in particular approximately 70 nm to roughly 180 nm.

Pearlescing pigments are pigments that have a pearlescent shine. Pearlescing pigments consist of thin sheets that have a high refraction index, and partially reflect light and are partially transparent to light. The pearlescent shine is generated by interference of the light hitting the pigment (interference pigment). Pearlescing pigments are usually thin sheets of the above-mentioned material, or contain the above-mentioned material as thin, multilayered films or as components arranged in parallel in a suitable carrier material.

The pearlescing pigments that can be used according to the invention are either natural pearlescing pigments such as fish silver (guanine/hypoxanthine mixed crystals from fish scales) or mother of pearl (from ground seashells), monocrystalline, sheet-like pearlescing pigments such as bismuth oxychloride and pearlescing pigments with a mica base and a mica/metal oxide base. The latter pearlescing pigments are micas that have been provided with a metal oxide coating.

By using the pearlescing pigments in the suspension according to the invention, shine and optionally also color effects are achieved.

Pearlescing pigments with a mica base and mica/metal oxide base are preferred according to the invention. Micas are phyllosilicates. The most important representatives of these silicates are muscovite, phlogopite, paragonite, biotite, lepidolite, and margarite. To produce the pearlescing pigments in conjunction with metal oxides, the mica, primarily muscovite or phlogopite, is coated with a metal oxide.

Suitable metal oxides are, inter alia, TiO₂, Cr₂O₃, and Fe₂O₃. Interference pigments and colored luster pigments are obtained as pearlescing pigments according to the invention by suitable coating. These pearlescing pigment types additionally have color effects as well as a glittering optical effect. Furthermore, the pearlescing pigments that can be used according to the invention also contain a color pigment that is not derived from a metal oxide.

The grain size of the pearlescing pigments that are preferably used is preferably at an average diameter X_{50.3} (volume average) between 1.0 and 100 μm, particularly preferably between 10.0 and 60.0 μm.

Within the meaning of the invention, speckles are understood to be macroparticles, in particular macrocapsules, that have an average diameter X_{50.3} (volume average) of greater than 300 μm, in particular of 300 to 1,500 μm, preferably 400 to 1,000 μm.

Speckles are preferably matrix capsules. The matrix is preferably colored. The matrix is formed for example by gelation, polyanion-polycation interactions or polyelectrolyte-metal ion interactions, and this is well known in the prior art, just like the preparation of particles using these matrix-forming materials. An example of a matrix-forming material is alginate. In order to prepare alginate-based speckles, an aqueous alginate solution, optionally also containing the active ingredient or active ingredients to be included, is drop-formed and is then hardened in a precipitation bath containing Ca²⁺ ions or Al³⁺ ions. Alternatively, other matrix-forming materials may be used instead of alginate.

The viscoelastic, solid surfactant composition necessarily contains, based on the total weight of the composition, a total amount of from 0.01 to 1.0 wt. % of said organic gelator compound. The organic gelator compound contained in the viscoelastic, solid surfactant composition is preferably contained in a total amount of from 0.01 to 0.9 wt. %, in particular 0.01 to 0.8 wt. %, more preferably 0.05 to 0.8 wt. %, very particularly preferably 0.1 to 0.8 wt. %, most preferably 0.1 to 0.7 wt. %, based on the total weight of the composition.

It is preferred according to the invention if the viscoelastic, solid surfactant composition contains at least one gelator compound selected from hydrogenated castor oil, hydroxystearic acid, N—(C₄-C₁₂) alkyl gluconamide, benzylidene alditol compound, or mixtures thereof. These preferred compounds satisfy the criteria of said organic gelator compound by definition. It is particularly preferred according to the invention if at least one benzylidene alditol compound of formula (I) is contained in the viscoelastic, solid surfactant composition as the organic gelator compound

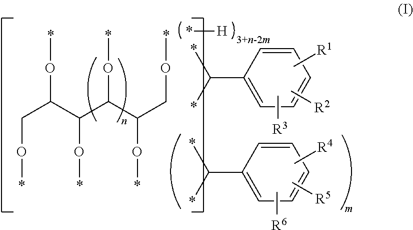

where
*— represents a single covalent bond between an oxygen atom of the alditol backbone and the provided functional group,
n represents 0 or 1, preferably 1,
m represents 0 or 1, preferably 1,
R¹, R² and represent, independently of one another, a hydrogen atom, a halogen
R³ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,
R⁴, R⁵ and represent, independently of one another, a hydrogen atom, a halogen
R⁶ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring.

Due to the steriochemistry of the alditols, it should be noted that, according to the invention, said benzylidene alditols are suitable in the L configuration or in the D configuration or a mixture of the two. Due to the natural availability, benzylidene alditol compounds are, according to the invention, preferably used in the D configuration. It has proven preferable if the alditol backbone of the benzylidene alditol compound according to formula (I) contained in the surfactant composition is derived from D-glucitol, D-mannitol, D-arabinitol, D-ribitol, D-xylitol, L-glucitol, L-mannitol, L-arabinitol, L-ribitol or L-xylitol.

Particularly preferred surfactant compositions of this kind are those that are characterized in that R¹, R², R³, R⁴, R⁵ and R⁶ according to the benzylidene alditol compound of formula (I) indicate, independently of one another, a hydrogen atom, methyl, ethyl, chlorine, fluorine or methoxy, preferably a hydrogen atom.

n according to the benzylidene alditol compound of formula (I) preferably represents 1.

m according to the benzylidene alditol compound of formula (I) preferably represents 1.

The surfactant composition according to the invention very particularly preferably contains, as the benzylidene alditol compound of formula (I), at least one compound of formula (I-1),

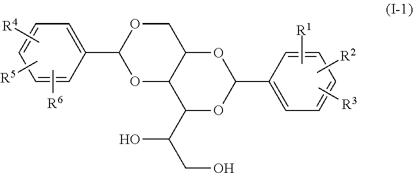

where R¹, R², R³, R⁴, R⁵ and R⁶ are as defined in formula (I). Most preferably, according to formula (I-1), R¹, R², R³, R⁴, R⁵ and R⁶ represent, independently of one another, a hydrogen atom, methyl, ethyl, chlorine, fluorine or methoxy, preferably a hydrogen atom.

The benzylidene alditol compound of formula (I) is most preferably selected from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-di-O-(3,4-dimethylbenzylidene)-D-sorbitol, or mixtures thereof.

The benzylidene alditol compound of formula (I) contained in the viscoelastic, solid surfactant composition is preferably contained in a total amount of from 0.01 to 1.0 wt. %, in particular 0.01 to 0.9 wt. %, more preferably 0.05 to 0.8 wt. %, most particularly preferably 0.1 to 0.7 wt. %, based on the total weight of the composition.

The benzylidene alditol compound of formula (I-1) contained in the viscoelastic, solid surfactant composition is preferably contained in a total amount of from 0.01 to 1.0 wt. %, in particular 0.01 to 0.9 wt. %, more preferably 0.05 to 0.8 wt. %, most particularly preferably 0.1 to 0.7 wt. %, based on the total weight of the composition.

The viscoelastic, solid surfactant composition according to the invention contains water. It is preferred if the surfactant composition contains water preferably in a total amount between 0 and 50 wt. %, in particular between 0 and 40 wt. %, more preferably between 0 and 30 wt. %, particularly preferably between 0 and 25 wt. %, based on the total weight of the composition. The proportion of water in the surfactant composition is very particularly preferably 20 wt. % or less, yet more preferably 15 wt. % or less, even more preferably 12 wt. % or less, in particular is from 4 to 20 wt. %, in particular 8 to 15 wt. %. The specifications in wt. % refer in each case to the total weight of the composition.

The solubility of said surfactant composition, and the stability thereof, is improved if the surfactant composition preferably contains in addition at least one organic solvent having at least one hydroxyl group, without an amino group and having a molecular weight of at most 500 g/mol.

Said organic solvent is in turn preferably selected from (C₂-C₈) alkanols having at least one hydroxyl group (particularly preferably selected from the group ethanol, ethylene glycol, 1,2-propandiol, glycerol, 1,3-propanediol, n-propanol, isopropanol, 1,1,1-trimethylolpropane, 2-methyl-1,3-propanediol, 2-hydroxymethyl-1,3-propanediol, or mixtures thereof), triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof.

It is again particularly preferred if said organic solvent is contained in a total amount of from 5 to 40 wt. %, in particular 10 to 35 wt. %.

The solution to the technical problem can be further optimized by at least one polyalkylene oxide compound having a weight-average molar mass M_{w} of at least 4,000 g/mol, in particular at least 6,000 g/mol, more preferably at least 8,000 g/mol, being preferably additionally contained in the surfactant composition. It has proven preferable if said polyalkylene oxide compound is selected from polyethylene oxide, ethylene oxide-propylene oxide copolymer, and mixtures thereof. Polyethylene oxide having a weight-average molar mass M_{w} of at least 4,000 g/mol, in particular at least 6,000 g/mol, more preferably at least 8,000 g/mol, is very particularly preferably used as the polyalkylene oxide compound.

In particular the stability of said surfactant composition is further improved if the surfactant composition additionally contains at least one polymeric polyol, in particular polyvinyl alcohol. According to the present invention, polymeric polyols have more than 3 hydroxyl groups. Suitable polymeric polyols preferably have an average molar mass of from 4,000 to 100,000 g/mol.

The surfactant composition according to the invention contains, based on the total weight thereof, a total amount of from 1 to 30 wt. %, in particular 2 to 20 wt. %, of the polymeric polyol.

Polyvinyl alcohols are thermoplastic materials that are manufactured as white to yellowish powders, usually by hydrolysis of polyvinyl acetate. Polyvinyl alcohol (PVOH) is resistant to almost all water-free organic solvents. Polyvinyl alcohols having an average molar mass of from 30,000 to 60,000 g/mol are preferred.

Preferred polyvinyl alcohols are those present as white-yellowish powders or granules having degrees of polymerization in the range of from approximately 100 to 2,500 (molar masses of approximately 4,000 to 100,000 g/mol) and degrees of hydrolysis of from 87 to 99 mol. %, which accordingly also contain a residual content of acetyl groups.

In the scope of the present invention, it is preferred if the surfactant composition comprises a polyvinyl alcohol whose degree of hydrolysis is preferably 70 to 100 mol. %, in particular 80 to 90 mol. %, particularly preferably 81 to 89 mol. %, and most particularly 82 to 88 mol. %. In a preferred embodiment, the water-soluble packaging consists of at least 20 wt. %, particularly preferably at least 40 wt. %, very particularly preferably at least 60 wt. %, and in particular at least 80 wt. %, of a polyvinyl alcohol of which the degree of hydrolysis is 70 to 100 mol. %, preferably 80 to 90 mol. %, particularly preferably 81 to 89 mol. %, and in particular 82 to 88 mol. %.

PVOH powders having the aforementioned properties and suitable for use in the at least one second phase are sold, for example, under the name Mowiol® or Poval® by Kuraray. Particularly suitable are the Poval® grades, in particular grades 3-83, 3-88 and 3-98 and Mowiol® 4-88 from Kuraray.

The water solubility of polyvinyl alcohol can be altered by post-treatment with aldehydes (acetalization) or ketones (ketalization). Particularly preferred and, due to their decidedly good solubility in cold water, particularly advantageous polyvinyl alcohols have been produced which can be acetalized or ketalized with the aldehyde groups or keto groups of saccharides or polysaccharides, or mixtures thereof. It is extremely advantageous to use the reaction products of polyvinyl alcohol and starch. Furthermore, the water solubility can be altered and thus set to desired values in a targeted manner by complexing with Ni salts or Cu salts or by treatment with dichromates, boric acid, or borax.

Surprisingly, it has been found that PVOH and/or gelatin is particularly well suited to producing surfactant compositions that meet the specifications outlined above. A surfactant composition according to the invention which has the PVOH and at least one organic solvent as described above is therefore particularly preferred.

In order to stabilize the viscoelastic, solid composition according to the invention, it is preferred if the composition additionally contains at least one stabilizer, selected from magnesium oxide, inorganic salt of Mg, Ca, Zn, Na or K (in particular sulfate, carbonate or acetate, more preferably magnesium sulfate, zinc acetate or calcium acetate), acetamide monoethanolamine, hexamethylenetetramine, guanidine, polypropylene glycol ether, salt from amino acids, or mixtures thereof.

It is preferred according to the invention if at least one bittering agent is contained in the viscoelastic, solid surfactant composition in order to increase product safety.

Preferred bittering agents have a bitterness value of at least 1,000, preferably at least 10,000, particularly preferably at least 200,000. In order to determine the bitterness value, the standardized method described in the European Pharmacopoeia (5th Edition, Main Volume, Stuttgart 2005, Volume 1, General Section, Monograph groups, 2.8.15 bitterness value, page 278) is used. An aqueous solution of quinine hydrochloride, whose bitterness value is fixed at 200,000, is used as a comparison. This means that 1 gram quinine hydrochloride makes 200 liters of water bitter. Interindividual differences in taste when organoleptically testing the bitterness are compensated for in this method by a correction factor.

Very particularly preferred bittering agents are selected from denatonium benzoate, glycosides, isoprenoids, alkaloids, amino acids, and mixtures thereof, particularly preferably denatonium benzoate.

Glycosides are organic compounds of the general structure R—O—Z, in which an alcohol (R—OH) is connected to a sugar moiety (Z) via a glycosidic bond.

Suitable glycosides are, for example, flavonoids such as guercetin or naringin or iridoid glycosides such as aucubin and in particular secoiridoid glycosides such as amarogentin, dihydrofoliamentin, gentiopicroside, gentiopicrin, swertiamarin, sweroside, gentioflavoside, centauroside, methiafolin, harpagoside and centapicrin, salicin or condurangin.

Isoprenoids are compounds which are formally derived from isoprene. Examples are in particular terpenes and terpenoides.

Suitable isoprenoids include, for example, sequiterpene lactones such as absinthin, artabsin, cnicin, lactucin, lactucopicrin or salonitenolide, monoterpene ketones (thujones) such as α-thujone or β-thujone, tetranortriterpenes (limonoids) such as desoxy limonene, desoxy limonene acid, limonin, ichangin, iso-obacunone acid, obacunone, obacunone acid, nomilin or nomilin acid, terpenes such as marrubin, premarrubin, camosol, camosol acid or quassin.

Alkaloids refer to naturally occurring, chemically heterogeneous, mostly alkaline, nitrogen-containing organic compounds of the secondary metabolism which act on the animal or human organism.

Suitable alkaloids are, for example, quinine hydrochloride, quinine hydrogen sulfate, quinine dihydrochloride, quinine sulfate, columbin and caffeine.

Suitable amino acids include, for example, threonine, methionine, phenylalanine, tryptophan, arginine, histidine, valine and aspartic acid.

Particularly preferred bitter substances are quinine sulfate (bitterness value=10,000), naringin (bitterness value=10,000), sucrose octaacetate (bitterness value=100,000), quinine hydrochloride, denatonium benzoate (bitterness value>100,000,000), and mixtures thereof, very particularly preferably denatonium benzoate (e.g. available as Bitrex®).

The viscoelastic, solid surfactant composition preferably contains, based on the total weight thereof, bittering agents in a total amount of at most 1 part by weight bitter substance to 250 parts by weight viscoelastic, solid surfactant composition (1:250), particularly preferably at most 1:500, very particularly preferably at most 1:1,000.

The viscoelastic, solid surfactant composition can be prepared by a liquid composition, containing, based on the total weight thereof, a total amount of from 0.01 to 1 wt. % of at least one of said organic gelator compounds (in particular at least one benzylidene alditol compound of formula (I) (vide supra)), in the presence of water, and 30 to 70 wt. % surfactant and at least one anionic surfactant and at least one non-ionic surfactant and possibly optional additives being brought to a temperature above the sol-gel transition temperature of the liquid composition, and subsequently the heated liquid composition being introduced into a mold, preferably into a cavity in a trough mold, and being cooled in said mold below the sol-gel transition temperature to form a viscoelastic solid shaped body.

It is also possible to firstly bring a first liquid composition, containing at least one of said organic gelator compounds, to a temperature above the sol-gel transition temperature of the first liquid composition and to mix said first liquid composition with a second liquid composition having a temperature below the sol-gel transition temperature of the first composition, containing water and at least one surfactant, to obtain a liquid composition, containing 0.01 to 1 wt. % of at least one of said organic gelator compounds, 30 to 70 wt. % of at least one surfactant, at least one anionic surfactant, at least one non-ionic surfactant and water, and to place said composition into a mold.

The particular liquid composition is placed in the mold to cure the liquid composition below the sol-gel transition temperature of the liquid composition. It is preferred according to the invention if, in order to form said shaped body, the liquid composition is cooled to no lower than 20° C., in particular to no lower than 25° C., particularly preferably to no lower than 30° C.

A corresponding shaped body can also be produced by extruding the viscoelastic, solid surfactant composition, and optionally subsequently rounding. This can result in a free-flowing product or pellet.

It is preferred according to the invention if the viscoelastic, solid surfactant composition of the first subject matter of the invention is in the form of a shaped body.

A shaped body is a single body that stabilizes itself in the shape imparted to it. This dimensionally stable body is formed from a molding compound (e.g. a composition) in such a way that this molding compound is deliberately brought into a predetermined shape, for example by pouring a liquid composition into a casting mold and then curing the liquid composition, for example as part of a sol-gel process. All conceivable molds are possible here, for example spheres, cubes, cuboids, circular disks, wells, shells, prisms, octahedrons, tetrahedrons, egg-shaped, dog, cat, mouse, horse, torso, bust, pillow, car, oval disk with embossed trademark, and much more.

It is preferred according to the invention if the shaped body of the viscoelastic, solid surfactant composition of the first subject matter of the invention has a weight of at least 1 g, preferably at least 5 g, particularly preferably at least 10 g.

It is preferred according to the invention if the shaped body of the viscoelastic, solid surfactant composition of the first subject matter of the invention has a weight of at most 80 g, in particular at most 70 g, particularly preferably at most 50 g, very particularly preferably at least 40 g and most preferably at most 30 g. In this context, the above-mentioned minimum weights of the shaped body are particularly preferred.

The shaped body of the viscoelastic, solid surfactant composition of the first subject matter of the invention very particularly preferably has a weight of from 10 to 80 g, in particular 10 to 70 g, more preferably 10 to 50 g, most preferably 10 to 30 g, for example 15 g or 25 g. It is in turn preferred if said shaped body contains surfactant in the total amounts characterized as preferred (vide supra).

The shaped body of said viscoelastic, solid composition can also contain at least two different viscoelastic, solid surfactant compositions of the first subject matter of the invention to form at least two phases, preferably at least two phases that are of different colors. For example, from a first viscoelastic, solid surfactant composition of the first subject matter of the invention, a trough-like shaped body can be produced as the first phase, in the trough of which a second viscoelastic, solid surfactant composition of the first subject matter of the invention is introduced as a second phase. The shaped body can likewise be formed of different viscoelastic, solid compositions which are arranged as phases that are layered one on top of the other.

A corresponding trough-like shaped body of the surfactant composition according to the invention can preferably be designed as a container having at least one trough, e.g. in the form of a well or a shell, such that the volume of the walls is smaller than the total volume of all troughs. The walls of a trough-like shaped body of this embodiment preferably have an average thickness of at most 5 mm, in particular at most 2 mm, more preferably at most 1 mm. The total volume of the troughs of this embodiment preferably has a volume of at least 5 ml, in particular at least 10 ml, more preferably at least 15 ml.

Within the meaning of the present invention, a phase is a spatial region in which physical parameters and the chemical composition are homogeneous. One phase differs from another phase in terms of its different features, for example ingredients, external appearance, etc. Preferably, different phases can be differentiated visually from one another. The consumer can thus clearly distinguish a first phase from a second phase. If the agent of the portion according to the invention has more than one first phase, then they can also preferably each be distinguished from one another with the naked eye because of their different coloration, for example. The same holds when two or more second phases are present. In this case as well, a visual differentiation of the phases, for example on the basis of a difference in coloration or transparency, is preferably possible. Within the meaning of the present invention, phases are thus self-contained regions that can be differentiated visually from one another by the consumer with the naked eye. The individual phases can have different properties in use.

It is preferred according to the invention if at least one bittering agent has been homogeneously incorporated into the shaped body and/or the surface of the shaped body has been coated with at least one bittering agent in order to increase product safety. It is preferable to incorporate the at least one bittering agent homogeneously in the shaped body as an ingredient of the viscoelastic, solid surfactant composition. Preferred bittering agents and amounts are those mentioned above (vide supra).

In order to prevent individual shaped bodies that are located together in packaging from adhering together, it can be preferred to powder the shaped bodies with a powdered solid. Preferred agents for powdering are selected from talc, sodium sulfate, starch, pectin, amylopectin, dextrin, lactic acid, lactose, or mixtures thereof.

The surfaces of the shaped body can be printed on for additional esthetic gain and/or to attach information or manufacturer names. The use of ink-jet printing is preferred in this case.

All the above-mentioned embodiments of the surfactant composition according to the invention are also preferred for providing a shaped body according to the invention.

The invention secondly relates to a portion containing at least one viscoelastic, solid surfactant composition of the first subject matter of the invention. It is preferred according to the invention if the portion contains the viscoelastic, solid surfactant composition of the first subject matter of the invention as a shaped body. It is in turn preferred if the portion contains, based on its total weight, the shaped body in an amount of at least 5 wt. %, in particular at least 15 wt. %, more particularly at least 50 wt. %, even more particularly at least 80 wt. %, yet more preferably at least 90 wt. %, particularly preferably at least 95 wt. %.

A portion is a discrete dosing unit which supplies an amount of textile treatment agent for use, preferably for use in a washing machine. The viscoelastic, solid surfactant composition according to the invention can either be the only textile treatment agent of the portion or be packaged in the portion together with at least one additional composition that is different from the viscoelastic, solid surfactant composition of the first subject matter of the invention, and in total form the textile treatment agent of the portion.

It is preferred according to the invention if the portion according to the invention contains at least one shaped body of the viscoelastic, solid surfactant composition of the first subject matter of the invention, which shaped body has a weight of at least 1 g, preferably at least 5 g, particularly preferably at least 10 g.

It is preferred according to the invention if the portion according to the invention contains at least one shaped body of the viscoelastic, solid surfactant composition of the first subject matter of the invention, which shaped body has a weight of at most 80 g, in particular at most 70 g, particularly preferably at most 50 g, very particularly preferably at most 40 g. In this context, the above-mentioned minimum weights of the shaped body are particularly preferred.

The portion according to the invention very particularly preferably has a shaped body of the viscoelastic, solid surfactant composition of the first subject matter of the invention having a weight of from 1 to 80 g, in particular 1 to 70 g, more preferably 1 to 50 g, further preferably 1 to 30 g, in particular 10 to 80 g, more particularly 10 to 70 g, more preferably 10 to 50 g, most preferably 10 to 30 g, for example 15 g or 25 g. It is in turn preferred if said shaped body contains surfactant in the total amounts characterized as preferred (vide supra).

Very particularly preferred portions are those of embodiments (P1) to (P4):

(P1): a portion containing, based on the weight of the portion, at least 80 wt. %, preferably at least 90 wt. %, of a shaped body of at least one viscoelastic, solid surfactant composition of the first subject matter of the invention, the shaped body having a weight of at least 1 g, preferably at least 5 g, particularly preferably at least 10 g, very particularly preferably from 10 to 30 g.

(P2): a portion containing, based on the weight of the portion, at least 80 wt. %, preferably at least 90 wt. %, of a shaped body of at least one viscoelastic, solid surfactant composition of the first subject matter of the invention, the shaped body being transparent and having a weight of at least 1 g, preferably at least 5 g, particularly preferably at least 10 g, very particularly preferably from 10 to 30 g.

(P3): a portion containing, based on the weight of the portion, at least 80 wt. %, preferably at least 90 wt. %, of a shaped body of at least one viscoelastic, solid surfactant composition containing, based on the total weight of the surfactant composition,
(i) 10 to 60 wt. % of at least one anionic surfactant, at least one C₉₋₁₃ alkylbenzene sulfonate preferably being contained as the anionic surfactant, and 5 to 35 wt. % of at least one non-ionic surfactant, at least one alkoxylated alcohol having 8 to 18 carbon atoms and on average 4 to 12 mol ethylene oxide (EO) per mol of alcohol preferably being contained as the non-ionic surfactant,
   with the proviso that surfactant is contained in a total amount of from 30 to 70 wt. %, in particular 35 to 70 wt. %,

and
(ii) a total amount of from 0.01 to 1 wt. % of at least one benzylidene alditol compound of formula (I)

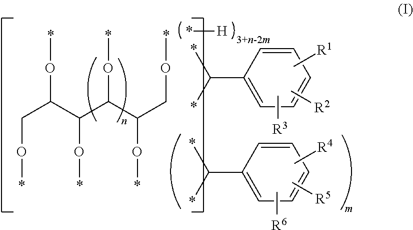

where
*— represents a single covalent bond between an oxygen atom of the alditol backbone and the provided functional group,
n represents 0 or 1, preferably 1,
m represents 0 or 1, preferably 1,
R¹, R² and represent, independently of one another, a hydrogen atom, a halogen
R³ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,
R⁴, R⁵ and represent, independently of one another, a hydrogen atom, a halogen
R⁶ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,

and
(iii) between 0 and 40 wt. %, particularly preferably between 0 and 25 wt. %, water, the shaped body having a weight of at least 1 g, preferably at least 5 g, particularly preferably at least 10 g, very particularly preferably from 10 to 30 g.

(P4): a portion containing, based on the weight of the portion, at least 80 wt. %, preferably at least 90 wt. %, of a shaped body of at least one viscoelastic, solid surfactant composition containing, based on the total weight of the surfactant composition,
(i) 10 to 60 wt. % of at least one anionic surfactant, at least one C₉-13 alkylbenzene sulfonate preferably being contained as the anionic surfactant, and 5 to 35 wt. % of at least one non-ionic surfactant, at least one alkoxylated alcohol having 8 to 18 carbon atoms and on average 4 to 12 mol ethylene oxide (EO) per mol of alcohol preferably being contained as the non-ionic surfactant,
   with the proviso that surfactant is contained in a total amount of from 30 to 70 wt. %,

and
(ii) a total amount of from 0.01 to 1 wt. % of at least one benzylidene alditol compound of formula (I)

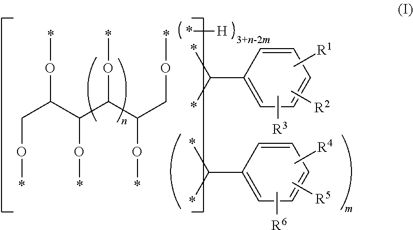

where
*— represents a single covalent bond between an oxygen atom of the alditol backbone and the provided functional group,
n represents 0 or 1, preferably 1,
m represents 0 or 1, preferably 1,
R¹, R² and represent, independently of one another, a hydrogen atom, a halogen
R³ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,
R⁴, R⁵ and represent, independently of one another, a hydrogen atom, a halogen
R⁶ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,

and
(iii) between 0 and 40 wt. %, particularly preferably between 0 and 25 wt. %, water, the shaped body being transparent and having a weight of at least 1 g, preferably at least 5 g, particularly preferably at least 10 g, very particularly preferably from 10 to 30 g.

All the above-mentioned embodiments of the surfactant composition according to the invention and of the shaped body according to the invention are also preferred for providing a portion according to the invention.

In order to prevent the user having direct skin contact with the viscoelastic, solid surfactant composition when using the portion, the shaped body is preferably enwrapped with a water-soluble material. A wrapping of this kind has also proven to be favorable in view of the storage stability of the shaped bodies according to the invention used in the portions.

Within the scope of a preferred embodiment, said shaped body of the portion is coated with at least one water-soluble material, preferably with at least one water-soluble polymer, on the surface. The coating can be carried out, for example, by spraying a solution or by dipping into a melt, the melting temperature preferably being below the sol-gel transition temperature in the latter method. It may in turn be preferred to powder the shaped body coated with at least one water-soluble material with at least one powdered solid. Preferred powdering agents are those mentioned above (vide supra).

According to another embodiment, a portion according to the invention can, as a pouch, contain at least one chamber having walls made of a water-soluble material, into which chamber at least one shaped body of a viscoelastic, solid surfactant composition of the first subject matter of the invention is introduced. Across all chambers of the portion added together, the compositions packaged therein in total result in the product of the portion to be dosed (here a textile treatment agent). Corresponding portions of this embodiment are well known to a person skilled in the art as pouch products.

A chamber is a space which is delimited by walls (e.g. by a film) and which can also exist without the product to be dosed (if necessary with a change in the form thereof). A layer of a surface coating is thus explicitly not covered by the definition of a wall. In a pouch, the water-soluble material forms the walls of the chamber and thus enwraps the compositions of the textile treatment agent.

A material is water-soluble if 0.1 g of the material dissolves in 800 ml water within 600 seconds at 20° C. with stirring (stirring speed magnetic stirrer 300 r m, stirring rod: 6.8 cm long, diameter 10 mm, low-form beaker 1,000 ml from the company Schott, Mainz) such that there are no longer any individual solid particles of the material that can be seen with the naked eye.

The water solubility of the material, in the form of a film, used for the wrapping in order to produce the pouch can be determined with the aid of a square film of said material (film: 22×22 mm having a thickness of 76 m) fixed in a square frame (edge length on the inside: 20 mm) in accordance with the following measurement protocol. Said framed film is dipped in 800 ml distilled water temperature-controlled to 20° C. in a 1 liter beaker having a circular base (from the company Schott, Mainz, low-form beaker 1,000 ml) such that the surface of the stretched film is arranged at a right angle to the base of the beaker, the upper edge of the frame is 1 cm below the water surface and the lower edge of the frame is oriented parallel to the base of the beaker such that the lower edge of the frame extends along the radius of the base of the beaker and the center of the lower edge of the frame is arranged over the center of the radius of the beaker base. The material should dissolve within 600 seconds with stirring (stirring speed magnetic stirrer 300 ram, stirring rod: 6.8 cm long, diameter 10 mm) such that there are no longer any individual solid film particles that can be seen with the naked eye.

The water-soluble material generally used to enwrap the shaped body preferably contains at least one water-soluble polymer. It is particularly preferable for the water-soluble material to contain polyvinyl alcohol or a polyvinyl alcohol copolymer.

Suitable water-soluble material and water-soluble films as the water-soluble material are preferably based on a polyvinyl alcohol or a polyvinyl alcohol copolymer of which the molecular weight is in each case in the range of from 10,000 to 1,000,000 μmol⁻¹, preferably 20,000 to 500,000 μmol⁻¹, particularly preferably 30,000 to 100,000 μmol⁻¹ and in particular 40,000 to 80,000 μmol⁻¹.

Polyvinyl alcohol is usually produced by hydrolysis of polyvinyl acetate, since the direct synthesis route is not possible. The same applies to polyvinyl alcohol copolymers, which are produced accordingly from polyvinyl acetate copolymers. It is preferable if the water-soluble material comprises at least one polyvinyl alcohol whose degree of hydrolysis constitutes from 70 to 100 mol. %, preferably 80 to 90 mol. %, particularly preferably 81 to 89 mol. % and in particular 82 to 88 mol. %.

Polymers selected from the group comprising acrylic-acid-containing polymers, polyacrylamides, oxazoline polymers, polystyrene sulfonates, polyurethanes, polyesters, polyether polylactic acid, and/or mixtures of the above polymers, can additionally be added to the water-soluble material.

In addition to vinyl alcohol, preferred polyvinyl alcohol copolymers comprise dicarboxylic acids as additional monomers. Suitable dicarboxylic acids are itaconic acid, malonic acid, succinic acid, and mixtures thereof, itaconic acid being preferred.

In addition to vinyl alcohol, likewise preferred polyvinyl alcohol copolymers comprise an ethylenically unsaturated carboxylic acid, the salt thereof or the ester thereof. In addition to vinyl alcohol, polyvinyl alcohol copolymers of this kind particularly preferably contain acrylic acid, methacrylic acid, acrylic acid ester, methacrylic acid ester, or mixtures thereof.

The water-soluble material of the film material used to provide the pouch walls has a preferred thickness in a range of from 65 to 180 μm, in particular 70 to 150 μm, more preferably 75 to 120 μm.

A bittering agent is preferably incorporated in said water-soluble material of the coating of the shaped body of the portion or of the walls of the pouch of the portion to increase product safety. Corresponding embodiments of the water-soluble material comprising bittering agents are described in documents EP-B1-2 885 220 and EP-B1-2 885 221. A preferred bittering agent is selected from the above-mentioned bittering agents (vide supra), in particular denatonium benzoate.

Portions according to the invention in the form of a pouch can be produced either by a vertical form fill seal (VFFS) method or by a thermoforming method. Walls of at least one chamber are particularly preferably created by sealing at least one film made of a water-soluble material, in particular by sealing in the context of a form fill seal method. The thermoforming method generally includes forming a first layer of a water-soluble film material in order to form at least one convex portion for receiving at least one composition therein in each case, filling the composition into the particular convex portion, covering the convex portions filled with the composition with a second layer of a water-soluble film material and sealing the first and second layers together at least around the convex portions.

The present invention further relates to a method for treating the substrate, comprising the method steps
(a) providing a surfactant-containing liquor by mixing 0.5 l to 40.0 l water with a viscoelastic, solid surfactant composition of the first subject matter of the invention, and
(b) bringing at least one textile into contact with the surfactant-containing liquor prepared in accordance with (a).

The following points are particular embodiments of the invention:
1. A viscoelastic, solid surfactant composition containing, based on the total weight thereof,
   (i) a total amount of from 30 to 70 wt. % of at least one surfactant, wherein at least one anionic surfactant and at least one non-ionic surfactant are contained
   and
   (ii) a total amount of from 0.01 to 1 wt. % of at least one organic gelator compound having a molar mass <1,000 g/mol, a solubility in water of less than 0.1 g/l (20° C.) and a structure containing at least one hydrocarbon structural unit having 6 to 20 carbon atoms (preferably at least one carbocyclic, aromatic structural unit) and additionally an organic structural unit covalently bonded to the above-mentioned hydrocarbon unit, which structure has at least two groups selected from —OH, —NH—, or mixtures thereof
   and
   (iii) water.
2. The composition according to point 1, wherein the surfactant composition has a storage modulus between 10³ Pa and 10⁸ Pa, preferably between 10⁴ Pa and 10⁸ Pa and a loss modulus (at 20° C., a deformation of 0.1% and a frequency of 1 Hz), and the storage modulus in the frequency range between 10⁻² Hz and 10 Hz is at least two times greater than the loss modulus, preferably at least five times greater than the loss modulus, particularly preferably at least ten times greater than the loss modulus.
3. The composition according to point 1 or 2, wherein comprising at least one organic gelator compound, selected from the group consisting of benzylidene alditol compound, hydrogenated castor oil, hydroxystearic acid, N—(C₄-C₁₂) alkyl gluconamide, or mixtures thereof.
4. The composition according to one of points 1 to 3, characterized in that it contains at least one benzylidene alditol compound of formula (I) as the organic gelator compound

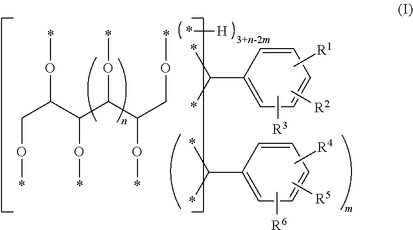

where
*— represents a single covalent bond between an oxygen atom of the alditol backbone and the provided functional group,
n represents 0 or 1, preferably 1,
m represents 0 or 1, preferably 1,
R¹, R² and represent, independently of one another, a hydrogen atom, a halogen
R³ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,
R⁴, R⁵ and represent, independently of one another, a hydrogen atom, a halogen
R⁶ atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring.
5. The composition according to one of the preceding points, characterized in that surfactant is contained in a total amount of from 30 to 65 wt. %, preferably 30 to 60 wt. %, more preferably 35 to 70 wt. %, even more preferably 35 to 65 wt. %, yet more preferably 35 to 60 wt. %, particularly preferably 40 to 70 wt. %, more particularly preferably 40 to 65 wt. %, even more particularly preferably 40 to 60 wt. %.
6. The composition according to one of the preceding points, characterized in that anionic surfactant is contained in a total amount of from 5 to 60 wt. %, preferably 10 to 60 wt. %, more preferably 15 to 60 wt. %, in particular 20 to 60 wt. %, particularly preferably 15 to 40 wt. %, more particularly preferably 20 to 40 wt. %.
7. The composition according to one of the preceding points, characterized in that non-ionic surfactant is contained in a total amount of from 5 to 35 wt. %, in particular 10 to 30 wt. %.
8. The composition according to one of the preceding points, characterized in that at least one anionic surfactant, selected from the group consisting of C₈₋₁₈ alkylbenzene sulfonates, olefin sulfonates, C₁₂₋₁₈ alkane sulfonates, ester sulfonates, alkyl sulfates, alkenyl sulfates, fatty alcohol ether sulfates, and mixtures thereof, is contained.
9. The composition according to one of the preceding points, characterized in that a mixture of sulfonate surfactant and sulfate surfactant is contained.
10. The composition according to one of the preceding points, characterized in that at least one compound of formula (A-3) is contained as the anionic surfactant,

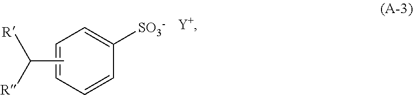

in which
R′ and R″ are, independently, H or alkyl, and together contain 9 to 19, preferably 9 to 15 and in particular 9 to 13 C atoms, and Y⁺ indicates a monovalent cation or the nth part of an n-valent cation (in particular Na+).
11. The composition according to one of the preceding points, characterized in that at least one compound of formula (A-1) is contained as the anionic surfactant,

R¹—O-(AO)ₙ—SO₃′X⁺ (A-1)
in which
R¹ represents a linear or branched, substituted or unsubstituted (C₁₀-C₂₀) alkyl functional group, (preferably a linear, unsubstituted (C₁₀-C₂₀) alkyl functional group),
AO represents an ethylene oxide (EO) group or propylene oxide (PO) group,
the index n is a number from 1 to 50,
X⁺ is a monovalent cation or the nth part of an n-valent cation.
12. The composition according to one of the preceding points, characterized in that at least one compound of formula (N-1) is contained as the non-ionic surfactant,

R²—O—(XO)ₘ—H, (N-1)
in which
R² represents a linear or branched C₈-C₁₈ alkyl functional group, an aryl functional group or an alkyl aryl functional group,
XO represents, independently, an ethylene oxide (EO) group or a propylene oxide (PO) group,
m represents integers from 1 to 50.
13. The composition according to one of points 4 to 12, characterized in that the alditol backbone according to formula (I) is derived from D-glucitol, D-mannitol, D-arabinitol, D-ribitol, D-xylitol, L-glucitol, L-mannitol, L-arabinitol, L-ribitol or L-xylitol.
14. The composition according to one of points 4 to 13, characterized in that R¹, R², R³, R⁴, R⁵ and R⁶ indicate, independently of one another, a hydrogen atom, methyl, ethyl, chlorine, fluorine or methoxy, preferably a hydrogen atom.
15. The composition according to one of the preceding points, characterized in that it contains at least one benzylidene alditol compound of formula (I-1) as the organic gelator compound

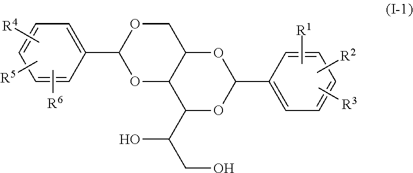

where R¹, R², R³, R⁴, R⁵ and R⁶ are as defined in point 1.
16. The composition according to one of points 1 to 16, characterized in that it contains at least one benzylidene alditol compound from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-di-O-(3,4-dimethylbenzylidene)-D-sorbitol, or mixtures thereof, as the organic gelator compound.
17. The composition according to one of points 1 to 16, characterized in that the organic gelator compound is contained in a total amount of from 0.01 to 1.0 wt. %, in particular 0.01 to 0.9 wt. %, more preferably 0.05 to 0.8 wt. %, and very particularly preferably 0.1 to 0.7 wt. %.
18. The composition according to one of points 1 to 17, characterized in that water is contained in a total amount between 0 and 50 wt. %, in particular between 0 and 40 wt. %, more preferably between 0 and 30 wt. %, particularly preferably between 0 and 25 wt. %.
19. The composition according to one of the preceding points, characterized in that it additionally contains at least one organic solvent having at least one hydroxyl group, without an amino group and having a molecular weight of at most 500 g/mol (particularly preferably selected from (C₂-C₈) alkanols having at least one hydroxyl group (particularly preferably ethanol, ethylene glycol, 1,2-propandiol, glycerol, 1,3-propanediol, n-propanol, isopropanol, 1,1,1-trimethylolpropane, 2-methyl-1,3-propanediol, 2-hydroxymethyl-1,3-propanediol), triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof).
20. The composition according to point 19, characterized in that said organic solvent is contained in a total amount of from 5 to 40 wt. %, in particular 10 to 35 wt. %.
21. The composition according to one of the preceding points, characterized in that the storage modulus is in a range of from 10⁵ Pa to 10⁷ Pa.
22. The composition according to one of the preceding points, characterized in that it has a yield point in the range of from 2.5 to 100 Pa, preferably from 3 to 80 Pa, measured using a cone-and-plate measuring system with 40 mm diameter and 2° opening angle at a temperature of 20° C.
23. The composition according to one of the preceding points, characterized in that it is present as a shaped body, in particular having a weight of at least 1 g, particularly preferably at least 5 g, very particularly preferably from 10 to 30 g.
24. A method for treating textiles comprising the method steps
   (a) providing an aqueous liquor by mixing 0.5 l to 40.0 l water with 0.5 to 100 g of a composition according to one of points 1 to 23, and
   (b) bringing at least one textile into contact with the aqueous liquor prepared in accordance with (a).
25. A method for preparing a solid surfactant composition according to one of points 1 to 23, characterized in that first a liquid composition, containing, based on the total weight thereof, a total amount of from 0.01 to 1 wt. % of at least one organic gelator compound according to point 1, in the presence of water, and 30 to 70 wt. % surfactant and at least one anionic surfactant and at least one non-ionic surfactant and possibly optional additives, is brought to a temperature above the sol-gel transition temperature of the liquid composition, and subsequently the heated liquid composition is introduced into a mold, preferably into a cavity in a trough mold, and is cooled in said mold below the sol-gel transition temperature to form a viscoelastic solid shaped body.

### EXAMPLES

The following compositions were prepared according to table 1.

TABLE 1
Shaped body

| | E1 | E2 | C1 | C2 | C3 |
|---|---|---|---|---|---|
| | [wt. %] | [wt. %] | [wt. %] | [wt. %] | [wt. %] |
| C₁₁₋₁₃ alkylbenzene sulfonic | 20.0 | 20.0 | 30.0 | — | — |
| acid | | | | | |
| (C₁₂₋₁₄) fatty alcohol ether | 6.0 | 6.0 | — | 30.0 | — |
| sulfate with 2 units ethylene | | | | | |
| oxide | | | | | |
| C₁₃₋₁₅ alkyl alcohol branched at | 15.0 | 15.0 | — | — | 30.0 |
| the 2 position and ethoxylated | | | | | |
| with 8 mol ethylene oxide | | | | | |
| sodium hydroxide | 6.2 | 6.2 | 6.2 | 6.2 | 6.2 |
| 1,3:2,4-di-O-benzylidene-D- | 0.5 | 1.0 | 0.5 | 0.5 | 0.5 |
| sorbitol | | | | | |
| C₁₂₋₁₈ fatty acid | 2.9 | 2.9 | 2.9 | 2.9 | 2.9 |
| Ethoxylated polyethyleneimine | 5.0 | 5.0 | 5.0 | 5.0 | 5.0 |
| Diethylenetriamine- | 0.6 | 0.6 | 0.6 | 0.6 | 0.6 |
| N,N,N′,N′,N″- | | | | | |
| penta(methylenephosphonic | | | | | |
| acid), heptasodium salt (sodium | | | | | |
| DTPMP) | | | | | |
| Citric acid | 3.2 | 3.2 | 3.2 | 3.2 | 3.2 |
| Boric acid | 0.6 | 0.6 | 0.6 | 0.6 | 0.6 |
| 1,2-propylene glycol | 5.6 | 5.6 | 5.6 | 5.6 | 5.6 |
| Ethanol | 2.1 | 2.1 | 2.1 | 2.1 | 2.1 |
| Soil release polymer consisting | 1.0 | 1.0 | 1.0 | 1.0 | 1.0 |
| of ethylene terephthalate and | | | | | |
| polyethylene oxide | | | | | |
| terephthalate | | | | | |
| Perfume | 1.2 | 1.2 | 1.2 | 1.2 | 1.2 |
| Protease, amylase, lipase, | 0.4 | 0.4 | 0.4 | 0.4 | 0.4 |
| cellulase, optical brightener | | | | | |
| Water | up to | up to | up to | up to | up to |
| | 100 | 100 | 100 | 100 | 100 |
| Storage modulus G′ [Pa] | 1.5 · 10⁴ | 3.4 · 10⁴ | — | — | — |
| Yield point [Pa] | 3.77 | 9.46 | — | — | — |

For the preparation, first a liquid mixture in each case according to a column of Table 1 was prepared without temperature-sensitive ingredients (enzymes, perfume) and heated to a temperature above the sol-gel transition temperature. The heated mixture is cooled to 30° C. while stirring and the remaining ingredients added thereto. 19 g of the resulting solution were rapidly introduced into a cube-shaped trough mold. The temperature of the solution in the trough was gradually lowered to room temperature. After solidification, the shaped body was removed from the trough. The shaped bodies E1 and E2 prepared in this way each had a loss modulus of the order of 10³ Pa. The compositions C1, C2 and C3 were liquid, i.e. no shaped body of a viscoelastic, solid surfactant composition formed in the trough. Composition C3 was additionally inhomogeneous and formed two phases. The storage modulus and yield point of the compositions C1 to C3 were therefore not determined.

All shaped bodies were transparent.

What is claimed is:

1. A viscoelastic, solid surfactant composition comprising, based on the total weight thereof,
(i) a total amount from 30 to 70 wt. % of at least one surfactant, wherein at least one anionic surfactant and at least one non-ionic surfactant are contained
and
(ii) a total amount from 0.01 to 1 wt. % of at least one organic gelator compound having a molar mass <1,000 g/mol, a solubility in water of less than 0.1 g/l (20° C.) and a structure comprising at least one hydrocarbon structural unit having 6 to 20 carbon atoms and additionally an organic structural unit covalently bonded to the above-mentioned hydrocarbon unit, which structure has at least two groups selected from —OH, —NH—, or mixtures thereof
and
(iii) water.

2. The composition according to claim 1, wherein the surfactant composition has a storage modulus between 10³ Pa and 10⁸ Pa and a loss modulus (at 20° C., a deformation of 0.1% and a frequency of 1 Hz), and the storage modulus in the frequency range between 10⁻² Hz and 10 Hz is at least two times greater than the loss modulus.

3. The composition according to claim 1, wherein it comprises at least one organic gelator compound, selected from benzylidene alditol compound, hydrogenated castor oil, hydroxystearic acid, N—(C₄-C₁₂) alkyl gluconamide, or mixtures thereof.

4. The composition according to claim 1, wherein it comprises at least one benzylidene alditol compound of formula (I) as the organic gelator compound 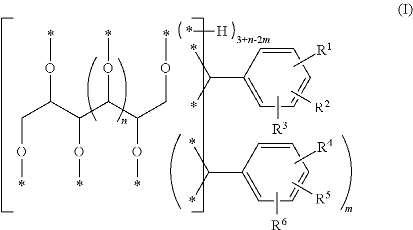
where
*— represents a single covalent bond between an oxygen atom of the alditol backbone and the provided functional group,
n represents 0 or 1,
m represents 0 or 1,
R¹, R² and R³ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring,
R⁴, R⁵ and R⁶ represent, independently of one another, a hydrogen atom, a halogen atom, a C₁-C₄ alkyl group, a cyano group, a nitro group, an amino group, a carboxyl group, a hydroxyl group, a —C(═O)—NH—NH₂ group, a —NH—C(═O)—(C₂-C₄ alkyl) group, a C₁-C₄ alkoxy group, a C₁-C₄ alkoxy-C₂-C₄ alkyl group; two of the functional groups together with the remainder of the molecule form a 5- or 6-membered ring.

5. The composition according to claim 1, wherein the amount of surfactant, in total, is from 30 to 70 wt. %.

6. The composition according to claim 1, wherein the amount of anionic surfactant, in total, is from 5 to 60 wt. %.

7. The composition according to claim 1, wherein the amount of non-ionic surfactant, in total, is from 5 to 35 wt. %.

8. The composition according to claim 1, wherein the at least one anionic surfactant, is selected from the group consisting of C₈₋₁₈ alkylbenzene sulfonates, olefin sulfonates, C₁₂₋₁₈ alkane sulfonates, ester sulfonates, alkyl sulfates, alkenyl sulfates, fatty alcohol ether sulfates, and mixtures thereof.

9. The composition according to claim 1, wherein comprising a mixture of sulfonate surfactant and sulfate surfactant.

10. The composition according to claim 1, wherein at least one compound of formula (A-3) comprises the anionic surfactant, 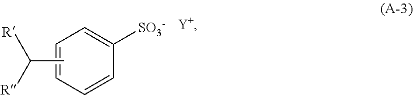
in which
R′ and R″ are, independently, H or alkyl, and together contain 9 to 19 C atoms, and Y⁺ indicates a monovalent cation or the nth part of an n-valent cation.

11. The composition according to claim 1, wherein at least one compound of formula (A-1) comprises the anionic surfactant
R¹—O-(AO)ₙ—SO₃′X⁺ (A-1)
in which
R¹ represents a linear or branched, substituted or unsubstituted (C₁₀-C₂₀) alkyl functional group,
AO represents an ethylene oxide (EO) group or propylene oxide (PO) group, the index n is a number from 1 to 50,
X⁺ is a monovalent cation or the nth part of an n-valent cation.

12. The composition according to claim 1, wherein at least one compound of formula (N-1) comprises the non-ionic surfactant
R²—O—(XO)ₘH, (N-1)
in which
R² represents a linear or branched C₈-C₁₈ alkyl functional group, an aryl functional group or an alkyl aryl functional group,
XO, independently, represents an ethylene oxide (EO) group or a propylene oxide (PO) group,
m represents integers from 1 to 50.

13. The composition according to claim 1, wherein the alditol backbone according to formula (I) is derived from D-glucitol, D-mannitol, D-arabinitol, D-ribitol, D-xylitol, L-glucitol, L-mannitol, L-arabinitol, L-ribitol or L-xylitol.

14. The composition according to claim 1, wherein R¹, R², R³, R⁴, R⁵ and R⁶ indicate, independently of one another, a hydrogen atom, methyl, ethyl, chlorine, fluorine or methoxy.

15. The composition according to claim 1, wherein it comprises at least one benzylidene alditol compound of formula (I-1) as the organic gelator compound

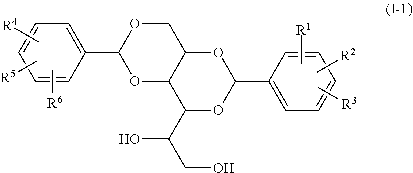

16. The composition according to claim 1, wherein it comprises at least one benzylidene alditol compound from 1,3:2,4-di-O-benzylidene-D-sorbitol; 1,3:2,4-di-O-(p-methylbenzylidene)-D-sorbitol; 1,3:2,4-di-O-(p-chlorobenzylidene)-D-sorbitol; 1,3:2,4-di-O-(2,4-dimethylbenzylidene)-D-sorbitol; 1,3:2,4-di-O-(p-ethylbenzylidene)-D-sorbitol; 1,3:2,4-di-O-(3,4-dimethylbenzylidene)-D-sorbitol, or mixtures thereof, as the organic gelator compound.

17. The composition according to claim 1, wherein the amount of the organic gelator compound is from 0.01 to 1.0 wt. %.

18. The composition according to claim 1, wherein the amount of water, in total, is between 0 and 50 wt. %.

19. The composition according to claim 1, wherein it additionally comprises at least one organic solvent having at least one hydroxyl group, without an amino group and having a molecular weight of at most 500 g/mol selected from (C₂-C₈) alkanols having at least one hydroxyl group, triethylene glycol, butyl diglycol, polyethylene glycols having a weight-average molar mass M_{w} of at most 500 g/mol, glycerol carbonate, propylene carbonate, 1-methoxy-2-propanol, 3-methoxy-3-methyl-1-butanol, butyl lactate, 2-isobutyl-2-methyl-4-hydroxymethyl-1,3-dioxolane, 2,2-dimethyl-4-hydroxymethyl-1,3-dioxolane, dipropylene glycol, or mixtures thereof.

20. A method for treating textiles comprising the method steps
(a) providing an aqueous liquor by mixing 0.5 l to 40.0 l water with 0.5 to 100 g of a composition according to claim 1, and
(b) bringing at least one textile into contact with the aqueous liquor prepared in accordance with (a).
